(19) United States
(12) Patent Application Publication
(10) Pub. No.: US 2025/0363996 A1
(43) Pub. Date: Nov. 27, 2025

(54) GENERALIZING AUDIO DEEPFAKE DETECTION BY EXPLORING STYLE-LINGUISTICS MISMATCH

(71) Applicant: Reality Defender, Inc., New York, NY (US)

(72) Inventors: Gaurav BHARAJ, Los Angeles, CA (US); Surya KOPPISETTI, Coquitlam (CA); Yi ZHU, Saint-Lambert (CA); Trang TRAN, Ha Noi (VN); Ben COLMAN, New York, NY (US); Ali SHAHRIYARI, Las Vegas, NV (US)

(73) Assignee: Reality Defender, Inc., New York, NY (US)

(21) Appl. No.: 19/213,893

(22) Filed: May 20, 2025

Related U.S. Application Data
(60) Provisional application No. 63/650,338, filed on May 21, 2024.

(51) Int. Cl. G10L 17/26; G10L 17/02; G10L 17/06

(52) U.S. Cl. CPC G10L 17/26; G10L 17/02; G10L 17/06

(57) ABSTRACT

Audio deepfake detection (ADD) is crucial to combat the potential misuse of synthesized speech from generative AI models. Existing ADD models suffer from generalization issues, with a large performance discrepancy seen between in-domain and out-of-domain data. Also, the black-box nature of the existing models limits their use in real-world scenarios where interpretation capabilities are required. Described is a new ADD training framework that explicitly uses the Style and LInguistics Mismatch (SLIM) in the fake class to separate it from the real class. The style-linguistics dependency is learned through a self-supervised pretraining stage, where only real samples are needed. Using frozen frontend encoders, SLIM outperforms benchmark methods on out-of-domain datasets while providing competitive results on in-domain datasets. The features learned by SLIM can be directly used to quantify the style-linguistics mismatch of deepfake samples, hence facilitating explainability.

### CROSS-REFERENCE TO RELATED APPLICATIONS

This application claims the benefit of U.S. Provisional Application No. 63/650,338, filed May 21, 2024, the entire contents of which is incorporated herein by reference.

### FIELD

The present disclosure relates generally to techniques for detecting AI-generated media.

### BACKGROUND

The growing interest in generative models has led to an expansion of publicly available tools that can closely mimic the voice of a real person. Synthesized voices can now be easily obtained using text-to-speech (TTS) or voice conversion (VC) systems from speech recordings that are only a few seconds long. When these generation tools are used by bad actors, their outputs, commonly referred to as ‘audio deepfakes’, can pose serious dangers such as impersonation of celebrities/family members for robocalls, illegal access to voice-guarded personal bank accounts, or forgery of audio evidence in court. Hence, reliable audio deepfake detection (ADD) tools are urgently needed.

State-of-the-art (SOTA) ADD systems rely on audio features learned by large self-supervised learning (SSL) models, such as Wav2vec, WavLM, and HuBert, among others. SOTA systems typically take the SSL encoder as a frontend feature extractor and append a classification backend to map the high-dimensional representation to a real/fake decision. These models are usually trained in a fully-supervised manner, with deepfake samples generated using off-the-shelf TTS/VC tools. However, with the constantly evolving voice generation techniques, ADD systems usually underperform for deepfakes crafted by unseen generative models (i.e., unseen attacks). To tackle this issue, some works have focused on the classifier architecture to extract more robust deepfake features from the input representation. More significant improvement has been reported by fine-tuning the upstream SSL frontend during downstream supervised training and increasing the diversity of labelled samples by data augmentation or customizing deepfakes via neural vocoders. While shown to be effective, fine-tuning frontends drastically increases the cost of training, especially considering that ADD models need to be retrained on a constant basis to combat emerging unseen attacks.

Additionally, outputs from existing ADD systems are hard to explain, i.e., it is unclear to a typical user why an ADD makes a certain prediction, which leads to lack of trust. For practical applications, it is useful to understand what information the model is relying on to make decisions, and under which circumstances would the model fail to successfully detect deepfakes. A group of works use explainable AI (XAI) methods to interpret model decisions, but they mainly rely on post-hoc visualizations such as saliency maps, which are known to be sensitive to training set-ups and therefore can be inconsistent. Some other models focus on specific vocal attributes, such as breath, or vocal tract to derive explanations. However, most of the interpretable attributes only account for a subset of deepfake-related characteristics, hence resulting in a large gap in detection performance compared to SOTA methods. Overall, however, their performance is usually sacrificed in exchange for interpretability.

### Related Works

### Audio Deepfake Detection and Current Challenges

SOTA ADD systems mainly rely on fully-supervised training, where the model architectures usually comprise one or more speech SSL frontends and a backend classifier. For example, Guo et al. developed a multi-fusion attentive classifier to process the output from a WavLM frontend. (Yinlin Guo, Haofan Huang, Xi Chen, He Zhao, and Yuehai Wang. Audio deepfake detection with self-supervised wavlm and multi-fusion attentive classifier. In ICASSP 2024-2024 IEEE International Conference on Acoustics, Speech and Signal Processing (ICASSP), pages 12702-12706. IEEE, 2024.) Yang et al. fused outputs from multiple SSL frontends and reported improvement over single frontends. (Yujie Yang, Haochen Qin, Hang Zhou, Chengcheng Wang, Tianyu Guo, Kai Han, and Yunhe Wang. A robust audio deepfake detection system via multi-view feature. In ICASSP 2024-2024 IEEE International Conference on Acoustics, Speech and Signal Processing (ICASSP), pages 13131-13135. IEEE, 2024.

However, studies have shown severe degradation of ADD systems when tested on unseen data, which raises questions as to whether existing systems can be applied and trusted in real-world scenarios. To address this issue, multiple works have explored methods to improve model generalizability. Typically with increased training cost, significant improvement has been reported when frontends are fine-tuned with backends classifiers during downstream training. Further improvements were achieved when fine-tuning is conducted with data augmentation, such as RawBoost and neural vocoder generated deepfakes. More recent works also show that distilled student models can generalize better than large teacher models. Still, a large discrepancy is seen between in-domain and out-of-domain performance. With the rapidly evolving generative techniques, models will need to be updated on a constant basis, and the fully supervised training with frontend fine-tuning can become even more costly.

In addition to generalization challenges, another limitation of existing ADD models is model interpretability. Several studies have shown that current SOTA models may be focusing on artifacts generated during voice synthesis (i.e., deepfake imperfections) and the non-speech segments. For instance, several studies have shown that current SOTA models may be focusing on artifacts introduced in the frequency domain during voice synthesis and/or the artifacts in non-speech segments. As voice generation models evolve, such imperfections may soon become less noticeable and imperceptible to human listeners. While a line of works proposed to extract speech-related features to account for this issue, such as breath and vocal tract and articulatory movement, the overall detection performance is below the SSL-based ones. Other works resort to XAI methods for model interpretation, such as SHAP scores, GradCAM, and Deep Taylor. However, these post-hoc analysis approaches have been shown to be sensitive to training set-ups. To summarize, the generalization and interpretability issues pose severe challenges for current ADD systems in real-world scenarios.

### Style-Linguistics Dependency

One common way speech is analyzed is by decomposing it into two subspaces, style and linguistics. The former (style) refers to non-verbal characteristics including short and long-term paralinguistic attributes, such as emotions, speaker identities, health state, ethnicities, etc., whereas the latter usually corresponds to the spoken verbal (i.e., textual) content of speech. For the majority of voice generative models, these two subspaces are assumed to be disentangled, hence are typically modelled independently. For example, a VC system changes the voice of an utterance by extracting and swapping the speaker embeddings of the source speaker with that of a target speaker, assuming that no linguistics information is encoded in the speaker embeddings. Similarly, modern TTS models synthesize speech by taking a text sequence and speaker ID tokens, then generate prosody features to increase speech expressiveness. While such disentanglement can be theoretically achieved, studies have shown that certain dependency exists between the two subspaces in real speech, such as the link between emotional states and word choices, the relation between prosody and language understanding, the impact of age on sentence coherence, just to name a few. Such delicate style-linguistics dependency, however, might be challenging to be modelled accurately by voice generation models.

### SUMMARY

Disclosed herein are systems, devices, methods, and non-transitory computer-readable storage media for classifying audio data (e.g., as real or fake). In an exemplary method, audio data is input into a trained machine learning model to obtain a classification result classifying the audio data as real or fake. In a first training stage, the machine learning model may have been trained to generate embeddings (which may be referred to herein as “dependency embeddings”) representing dependencies between style and linguistics information in bona fide (real) audio data. As used herein, style information may refer to non-verbal characteristics of the audio data and linguistic information may refer to the textual content of the audio data. In a second training stage, a classification head of the machine learning model may have been trained using labeled audio data (including bona fide audio data and synthetic/fake audio data) to classify audio data as real or fake based on dependency embeddings of the labeled audio data generated using the machine learning model. Style and linguistics information in real audio data may be relatively closely aligned, while in synthetic/fake audio data, there may be a relatively larger divergence/mismatch between style and linguistics. Thus, the machine learning model may determine that audio data is more likely fake when there is a relatively larger mismatch between style and linguistics and may determine that audio data is more likely fake when there is a relatively smaller mismatch between style and linguistics in the audio data.

The classification output can be utilized by the system to execute actions to improve the integrity and security of, for example, conferencing platforms, communications systems, financial systems, media platforms, etc. For instance, an exemplary system be integrated into communications systems and may, for instance, automatically terminate a call (e.g., telephone call) based on a classification result indicating that the audio is fake and/or issue user alerts. This measure would help protect end-users from fraudulent phone interactions, improving overall communication security. An exemplary system may be integrated into a virtual meeting software application and may generate an alert flagging, or automatically block participants using deepfake audio feeds in virtual meetings. An exemplary system may be integrated into automated transcription services to generate a classification result before converting speech to text, alerting users to deepfakes. On content platforms where live or recorded audio is broadcast/accessible, the techniques disclosed herein may be used filter or flag content classified including fake audio. It should be understood that the above examples are for illustrative purposes only, and the techniques disclosed herein may be used in numerous additional, or alternative, applications.

The techniques disclosed herein provide a generalizable and explainable ADD model that leverages the style-linguistics mismatch via self-supervised contrastive learning. As noted above, in real speech, a certain dependency can exist between the linguistics information embedded in the verbal content and the style information embedded in the vocal attributes such as speaker identity and emotion. TTS and VC systems, by nature, distort a subset of style attributes, potentially causing a mismatch between the linguistics and style subspaces. The provided two-stage framework explicitly studies the Style-LInguistics Mismatch (SLIM) in the fake class to separate it from the real class. During stage I, the style-linguistics dependency in the bonafide class is learned by self-contrasting the style and linguistic subspace representations and generating a set of dependency features from each subspace. This pair of style-linguistics dependency features is expected to be highly correlated for real speech and minimally correlated for deepfakes. Since the dependency features are learned to capture only cross-subspace mismatch, they are fused with the original style and linguistics representations in Stage 2 for supervised training, where details about deepfake imperfections can be complemented.

The techniques disclosed herein provide a technical solution to a technical problem associated with audio deepfake detection. As discussed above, existing audio deepfake detection techniques fail to generalize well to unseen data, which raises questions as to whether existing systems can be applied and trusted in real-world scenarios. Existing techniques for improving generalizability of deepfake detection models typically involve fine-tuning an upstream self-supervised learning frontend during downstream supervised training and increasing the diversity of labelled samples. However, this drastically increases the amount of training data, compute resources, memory, and cost to train an audio deepfake detection model. The techniques disclosed herein do not rely on such techniques; rather, the techniques disclosed herein involve training a machine learning model to learn dependencies between style and linguistics in bona fide (real) audio data, and then training the machine learning model to identify fake (e.g., deepfake) audio data based on a discrepancies between style and linguistics that are uncharacteristic of real audio data. As discussed above, many deepfake generation models model style and linguistics separately, resulting in a disentanglement between the two subspaces. However, certain dependency exists between the two subspaces in real speech, such as the link between emotional states and word choices, the relation between prosody and language understanding, the impact of age on sentence coherence. Thus, the deepfake detection techniques disclosed herein can effectively generalize across different deepfake generation models by identifying discrepancies between style and linguistics in fake audio that is uncharacteristic of real audio.

In sum, some technical advantages of the disclosed method are summarized as follows. The described audio deepfake detection method leverages the style-linguistics mismatch in deepfake audios to detect them. The new framework, SLIM, relies on self-supervised contrastive learning requiring only real speech samples. The techniques disclosed herein to achieve better generalization to unseen attacks than existing models. Without fine-tuning large frontend encoders or increasing the amount of labeled data, SLIM outperforms ADD benchmarks on two out-of-domain datasets (In-the-wild and MLAAD) and provides competitive performance on in-domain data (ASVspoof2019 & 2021). Unlike common ADD black-box models, the style-linguistics features learned by SLIM can be used to better interpret model decisions and explain the improvement in performance.

According to an aspect, an exemplary method for classifying audio data comprises: inputting the audio data into a trained machine-learning model, wherein the trained machine-learning model is configured to: generate, using a style encoder of the machine-learning model, one or more style embeddings representing nonverbal characteristics of the audio data; generate, using a linguistic encoder of the machine-learning model, one or more linguistic embeddings representing textual content of the audio data; generate one or more dependency embeddings representing dependencies between the one or more style embeddings and the one or more linguistic embeddings; inputting the one or more dependency embeddings into a classification head of the machine-learning model; and obtaining, from the trained machine-learning model, a classification result of whether the audio data is real or fake.

Optionally, the audio data comprises real human speech, synthetic human speech, or both real human speech and synthetic human speech.

Optionally, the one or more machine learning models have been trained using bona fide audio data to learn dependencies between nonverbal characteristics and textual content in real human speech.

Optionally, determining a first subset of the one or more dependency embeddings comprises: inputting the one or more style embeddings into a style compressor; compressing the one or more style embeddings to create one or more style dependency embeddings

Optionally, determining a second subset of the one or more dependency embeddings comprises: inputting the one or more linguistic embeddings into a linguistic compressor; and compressing the one or more linguistic embeddings to create one or more linguistic dependency embeddings.

Optionally, the style compressor and the linguistics compressor have been trained to minimize a difference between the one or more style dependency embeddings and the one or more linguistic dependency embeddings by: inputting bona fide audio data into the style encoder of the machine-learning model and the linguistic encoder of the machine-learning model; generating one or more style embeddings representing nonverbal characteristics of the audio data using the style encoder; generating one or more linguistic embeddings representing textual content of the audio data using the linguistic encoder; inputting the one or more style embeddings into the style compressor; compressing the one or more style embeddings to create one or more style dependency embeddings; inputting the one or more linguistic embeddings into the linguistic compressor; compressing the one or more linguistic embeddings to create one or more linguistic dependency embeddings; and updating one or both of the style compressor and the linguistic compressor to minimize a difference between style dependency embeddings and linguistic dependency embeddings generated using the style compressor and the linguistic compressor.

Optionally, minimizing the difference between the one or more style dependency embeddings and the one or more linguistic dependency embeddings comprises minimizing a self-contrastive loss.

Optionally, the style compressor and the linguistics compressor have been trained via self-supervised learning using bona fide audio data comprising real human speech.

Optionally, the method includes generating one or more supplementary style embeddings based on the one or more style embeddings, wherein the one or more supplementary style embeddings include information-rich portions of the input audio data.

Optionally, the method includes generating one or more supplementary linguistic embeddings based on the one or more linguistic embeddings, wherein the one or more supplementary linguistic embeddings include information-rich portions of the input audio data.

Optionally, the method includes concatenating the one or more supplementary style embeddings, one or more supplementary linguistic embeddings, one or more style dependency embeddings, and one or more linguistic dependency embeddings to one another; and inputting the concatenated embeddings into the classifier module.

Optionally, the one or more supplementary style embeddings and one or more supplementary linguistic embeddings are generated using an attentive statistics pooling module and a multi-layer perceptron module.

Optionally, the one or more style embeddings represent one or more attributes selected from the group comprising: speaker identity, gender, emotion, accent, tone, speech rate, health state, age, vocal pitch, vocal intensity, and cognitive state.

Optionally, the classification head has been trained to classify audio as real or fake via supervised learning using labeled audio data.

Optionally, the style compressor and the linguistics compressor are trained in a first training phase using only bona fide audio data, and wherein the classification head is trained during a second training phase using labeled bona fide audio data and labeled fake audio data.

Optionally, the method includes permitting access to a computing resource or protected endpoint based on the classification result, wherein the classification result indicates that the audio is real.

Optionally, the method includes restricting access to a computing resource or protected endpoint based on the classification result, wherein the classification result indicates that the audio is fake.

Optionally, the method includes displaying an alert via a user interface based on the classification result, wherein the classification result indicates that the audio is fake.

According to an aspect, an exemplary system for classifying audio data comprises: one or more processors, a memory, and one or more programs, wherein the one or more programs are stored in the memory and configured to be executed by the one or more processors, the one or more programs including instructions for: inputting the audio data into a trained machine-learning model, wherein the trained machine-learning model is configured to: generate, using a style encoder of the machine-learning model, one or more style embeddings representing nonverbal characteristics of the audio data; generate, using a linguistic encoder of the machine-learning model, one or more linguistic embeddings representing textual content of the audio data; generate one or more dependency embeddings representing dependencies between the one or more style embeddings and the one or more linguistic embeddings; inputting the one or more dependency embeddings into a classification head of the machine-learning model; and obtaining, from the trained machine-learning model, a classification result of whether the audio data is real or fake.

According to an aspect, an exemplary non-transitory computer-readable storage medium stores one or more programs for detecting deepfake images in a video, the one or more programs comprising instructions, which when executed by one or more processors of an electronic device, cause the electronic device to: input the audio data into a trained machine-learning model, wherein the trained machine-learning model is configured to: generate, using a style encoder of the machine-learning model, one or more style embeddings representing nonverbal characteristics of the audio data; generate, using a linguistic encoder of the machine-learning model, one or more linguistic embeddings representing textual content of the audio data; generate one or more dependency embeddings representing dependencies between the one or more style embeddings and the one or more linguistic embeddings; input the one or more dependency embeddings into a classification head of the machine-learning model; and obtain, from the trained machine-learning model, a classification result of whether the audio data is real or fake.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 illustrates an exemplary system for classifying deepfake audio, according to some embodiments.

FIG. 2 illustrates an exemplary method for classifying deepfake audio, according to some embodiments.

FIG. 3 illustrates an exemplary method training one or more machine learning models to learn dependencies between style and linguistics in bona fide audio, according to some embodiments.

FIG. 4 shows, an exemplary two-stage training process of SLIM, according to some embodiments. Stage-1 relies on bonafide-only samples aggregated from multiple open-source speech datasets, guided by self-contrastive loss. Stage-2 is a supervised training scheme which requires binary labels (fake/bonafide) for each sample. The snowflake and fire symbols represent frozen and updated modules, respectively.

FIG. 5 shows, in color, example cosine distance (log scale) values calculated between the style and linguistics dependency features for ASVspoof2021 DF eval, In-the-wild, and MLAAD-EN. Whiskers from top to bottom represent the 75% quartile, median, and 25% quartile of the distribution.

FIGS. 6A-6D show, in color, example projected embeddings using t-SNE for (A) subspace representations from bonafide, (B) subspace representations from deepfakes, (C) dependency features from bonafide, and (D) dependency features from deepfakes. Data distributions are visualized on the upper and right side of the embedding plots. In FIGS. 6A-6D, red represents ASVspoof2021, green represents In-the-wild, and blue represents MLAAD-EN. These embeddings are the input to stage-2 of the two-stage SLIM training process and hence have not been updated by supervised training. The dependency features show larger discrimination power between bonafide and deepfakes, meanwhile less shift between datasets.

FIG. 7 shows, in color, example mel-spectrograms of speech recordings selected from In-the-wild exhibiting typical characteristics of a larger group of audios. The left column shows the ones that are missed by the dependency features but correctly identified by the SSL embeddings, whereas the right column shows the other way around. The first row corresponds to real samples and the second row to fake samples.

FIG. 8 shows, in color, Spearman correlation coefficients calculated across all layers from two pretrained Wav2vec-XLSR backbones. Blue highlights layers 0-10 from Wav2vec-SER to represent style information. Red highlights layers 14-21 from Wav2vec-ASR to represent linguistics information. The correlation values between the selected layers can be read from the overlapping region.

FIG. 9 shows, in color, projected WavLM embeddings for real and fake classes from the four employed datasets.

FIG. 10 shows, in color, architecture of an exemplary compression module, according to some embodiments.

FIG. 11 shows an exemplary computer system according to some embodiments.

### DETAILED DESCRIPTION

Disclosed herein are systems, devices, methods, and non-transitory computer-readable storage media for classifying audio data (e.g., as real or fake). In an exemplary method, audio data is input into a trained machine learning model to obtain a classification result classifying the audio data as real or fake. In a first training stage, the machine learning model may have been trained to generate embeddings (which may be referred to herein as “dependency embeddings”) representing dependencies between style and linguistics information in bona fide (real) audio data. As used herein, style information may refer to non-verbal characteristics of the audio data and linguistic information may refer to the textual content of the audio data. In a second training stage, a classification head of the machine learning model may have been trained using labeled audio data (including bona fide audio data and synthetic/fake audio data) to classify audio data as real or fake based on dependency embeddings of the labeled audio data generated using the machine learning model. Style and linguistics information in real audio data may be relatively closely aligned, while in synthetic/fake audio data, there may be a relatively larger divergence/mismatch between style and linguistics. Thus, the machine learning model may determine that audio data is more likely fake when there is a relatively larger mismatch between style and linguistics and may determine that audio data is more likely fake when there is a relatively smaller mismatch between style and linguistics in the audio data.

The classification output can be utilized by the system to execute actions to improve the integrity and security of, for example, conferencing platforms, communications systems, financial systems, media platforms, etc. For instance, an exemplary system be integrated into communications systems and may, for instance, automatically terminate a call (e.g., telephone call) based on a classification result indicating that the audio is fake. This measure would help protect end-users from fraudulent phone interactions, improving overall communication security. An exemplary system may be integrated into a virtual meeting software application and may generate an alert flagging, or automatically block participants using deepfake audio feeds in virtual meetings. An exemplary system may be integrated into automated transcription services to generate a classification result before converting speech to text, alerting users to deepfakes. On content platforms where live or recorded audio is broadcast/accessible, the techniques disclosed herein may be used filter or flag content classified including fake audio. It should be understood that the above examples are for illustrative purposes only, and the techniques disclosed herein may be used in numerous additional, or alternative, applications.

The techniques disclosed herein provide a generalizable and explainable ADD model that leverages the style-linguistics mismatch via self-supervised contrastive learning. As noted above, in real speech, a certain dependency can exist between the linguistics information embedded in the verbal content and the style information embedded in the vocal attributes such as speaker identity and emotion. TTS and VC systems, by nature, distort a subset of style attributes, potentially causing a mismatch between the linguistics and style subspaces. The provided two-stage framework explicitly studies the Style-LInguistics Mismatch (SLIM) in the fake class to separate it from the real class. During stage I, the style-linguistics dependency in the bonafide class is learned by self-contrasting the style and linguistic subspace representations and generating a set of dependency features from each subspace. This pair of style-linguistics dependency features is expected to be highly correlated for real speech and minimally correlated for deepfakes. Since the dependency features are learned to capture only cross-subspace mismatch, they are fused with the original style and linguistics representations in Stage 2 for supervised training, where details about deepfake imperfections can be complemented.

The techniques disclosed herein provide a technical solution to a technical problem associated with audio deepfake detection. As discussed above, existing audio deepfake detection techniques fail to generalize well to unseen data, which raises questions as to whether existing systems can be applied and trusted in real-world scenarios. Existing techniques for improving generalizability of deepfake detection models typically involve fine-tuning an upstream self-supervised learning frontend during downstream supervised training and increasing the diversity of labelled samples. However, this drastically increases the amount of training data, compute resources, memory, and financial cost to train an audio deepfake detection model. The techniques disclosed herein do not rely on such techniques; rather, the techniques disclosed herein involve training a machine learning model to learn dependencies between style and linguistics in bona fide (real) audio data, and then training the machine learning model to identify fake (e.g., deepfake) audio data based on a discrepancies between style and linguistics that are uncharacteristic of real audio data. As discussed above, many deepfake generation models model style and linguistics separately, resulting in a disentanglement between the two subspaces. However, certain dependency exists between the two subspaces in real speech, such as the link between emotional states and word choices, the relation between prosody and language understanding, the impact of age on sentence coherence. Thus, the deepfake detection techniques disclosed herein can effectively generalize across different deepfake generation models by identifying discrepancies between style and linguistics in fake audio that is uncharacteristic of real audio.

In sum, some technical advantages of the disclosed method are summarized as follows. The described audio deepfake detection method leverages the style-linguistics mismatch in deepfake audios to detect them. The new framework, SLIM, relies on self-supervised contrastive learning requiring only real speech samples. The techniques disclosed herein to achieve better generalization to unseen attacks than existing models. Without fine-tuning large frontend encoders or increasing the amount of labeled data, SLIM outperforms ADD benchmarks on two out-of-domain datasets (In-the-wild and MLAAD) and provides competitive performance on in-domain data (ASVspoof2019 & 2021). Unlike common ADD black-box models, the style-linguistics features learned by SLIM can be used to better interpret model decisions and explain the improvement in performance.

The following description sets forth exemplary methods, parameters, and the like. It should be recognized, however, that such description is not intended as a limitation on the scope of the present disclosure but is instead provided as a description of exemplary embodiments.

Although the following description uses terms “first,” “second,” etc. to describe various elements, these elements should not be limited by the terms. These terms are only used to distinguish one element from another. For example, a first graphical representation could be termed a second graphical representation, and, similarly, a second graphical representation could be termed a first graphical representation, without departing from the scope of the various described embodiments. The first graphical representation and the second graphical representation are both graphical representations, but they are not the same graphical representation.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

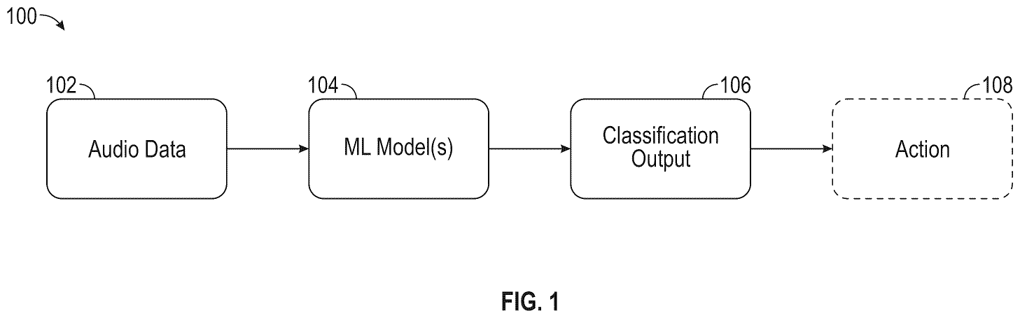

FIG. 1 illustrates an exemplary system 100 for classifying audio as real or fake and executing one or more downstream actions based on the classification. In real speech, dependencies can exist between the linguistics information embedded in the verbal content of speech and the style information embedded in the nonverbal content of speech, such as vocal attributes including speaker identity and emotion. Text-To-Speech and voice conversion systems, by nature, distort a subset of style attributes, which may cause a mismatch between the linguistics and style subspaces. System 100 leverages the dependencies present in real speech and/or the mismatch between the linguistics and style in fake/synthetic speech to improve ability of one or more machine learning models to detect deepfake audio.

System 100 may include one or more machine learning models 104 trained to receive audio data 102 and classify the audio data as real or fake (e.g., synthetic, generated using a machine learning model, etc.). One or more of the machine learning models 104 may be trained using bona fide human speech to learn dependencies between style, which as discussed above may refer to nonverbal content of the speech, and linguistics, which may refer to textual (e.g., verbal) content of the speech. The one or more machine learning models 104 may process audio data 102 to generate a classification output 106 indicating whether the audio data 102 is real or fake, leveraging embeddings capturing information about the relationship between style and linguistics of the human speech in the audio data 102. It should be understood that the classification output 106 may include, for instance, a confidence score or likelihood that the audio data is real or fake.

In some examples, system 100 may be configured to execute one or more actions 108 based on the classification output 106. For instance, in some examples, once a classification output 106 is generated—indicating, for example, audio data 102 is either real or fake—the system may select or initiate an action 108, e.g., in accordance with user-defined rules or automated procedures. In some examples, the action can be carried out on the same device performing the classification. For instance, the system may store an event log in persistent local storage, trigger an alert mechanism in an on-premises security application, and/or initiate a separate software routine that processes the flagged audio data 102 for further analysis. In some examples, system 100 may leverage a network communication interface to transmit instructions to remote devices or servers to execute one or more actions 108 upon generation of the classification output 106. This transmission may be executed using protocols such as TCP/IP or application-level APIs (e.g., REST, gRPC) over secure channels (e.g., HTTPS). As an example, the system can upload a suspicious-audio notification to a dedicated monitoring server, which might in turn execute one or more actions 108 such as denying access to a controlled resource or alerting an administrator to examine the flagged audio data 102. In some instances, the system 100 may forward classification outputs 106 to a cloud-based orchestration service that dispatches workflow tasks, such as metadata logging, targeted user notifications, etc.

System 100 may include one or more electronic devices configured to execute instructions embodied in software. System 100 may be configured for local or remote execution, depending on the user's operational needs. For example, the entire software pipeline can run on a singular edge device with embedded GPUs, wherein all data and computations are handled locally and no external communication is required. Alternatively, the system can interface with a remote server or cloud platform through standard protocols (e.g., REST APIs over HTTPS) to handle memory-intensive operations, such as large-batch training and inference. This flexibility allows deployment in different production ecosystems: from on-premise data centers where data security is a priority, to multi-cloud architectures that can dynamically scale resource allocation in response to peak computational demands. In certain implementations, a hybrid approach may be employed, where preprocessing and analysis (e.g., inference) may happen locally, and bulk model training operations—such as multi-epoch fine-tuning—may take place on dedicated GPU clusters in the cloud.

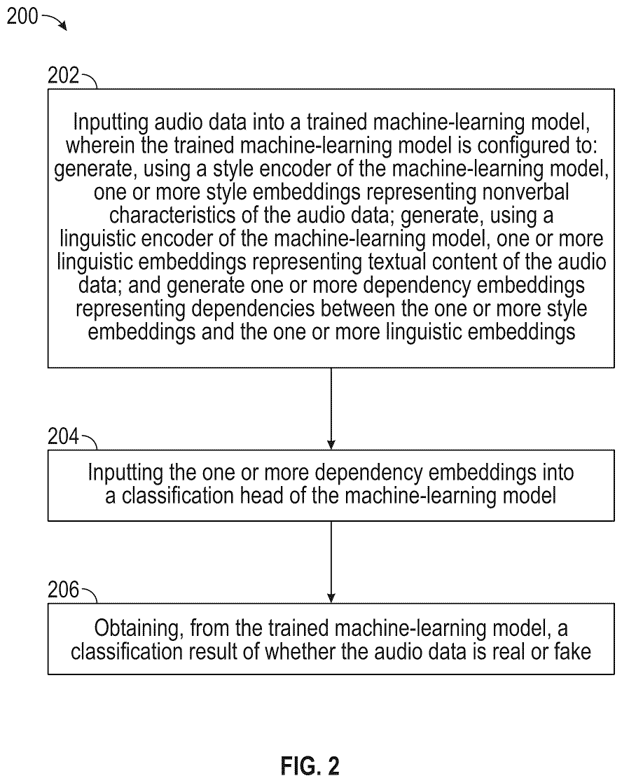

FIG. 2 illustrates an exemplary process 200 for classifying deepfake audio. Process 200 may be performed using one or more aspects of system 100. Process 200 is performed, for example, using one or more electronic devices implementing a software platform. In some examples, process 200 is performed using a client-server system, and the blocks of process 200 are divided up in any manner between the server and a client device. In other examples, the blocks of process 200 are divided up between the server and multiple client devices. Thus, while portions of process 200 may be described herein as being performed by particular devices of a client-server system, it will be appreciated that process 200 is not so limited. In other examples, process 200 is performed using only a client device or only multiple client devices. In process 200, some blocks are, optionally, combined, the order of some blocks is, optionally, changed, and some blocks are, optionally, omitted. In some examples, additional steps may be performed in combination with the process 200. Accordingly, the operations as illustrated (and described in greater detail below) are exemplary by nature and, as such, should not be viewed as limiting.

At block 202, process 200 may include inputting audio data into one or more machine learning models. The one or more machine learning models may have been trained to determine dependencies between style and linguistics in audio data and to classify audio as real or fake based on such dependencies. As described above, as used herein, style may refer to nonverbal characteristics of the audio data and linguistics may refer to textual (e.g., verbal) content of the audio data. In synthetic/deepfake audio, there may be a mismatch between the style and linguistics of human speech, while in real audio, style and linguistics may be relatively more closely aligned. The one or more machine learning models may be trained to identify when style and linguistics are closely aligned (indicating the audio is real) and when there is a mismatch between style and linguistics (indicating the audio is a deepfake).

The audio data input into the one or more machine learning models may include real human speech, synthetic (e.g., fake) human speech, or both real human speech and synthetic human speech. The one or more machine learning models may have been trained using bona fide audio data to learn dependencies between style and linguistics in real human speech. The bona fide audio data may not include any synthetically generated human speech such that the one or more machine learning models can learn to capture dependencies between style and linguistics in real human speech, thus enabling the one or more machine learning models to effectively identify misalignment between style and linguistics in fake human speech.

The audio data may be input into the one or more machine learning models as a real-time stream (e.g., data captured by a live microphone may be continuously fed into the one or more machine learning models). The audio data may be input into the one or more machine learning models using a batch processing approach. For instance, a predefined duration of recorded audio may be collected and input into the one or more machine learning models as a batch. The audio data may be input into the one or more machine learning models as discrete files (e.g., WAV, MP3). Files may be processed independently or in a sequential or parallel manner, depending on the system configuration. In some examples, the audio data may undergo transformations such as resampling, normalization, or splitting into frames before being input into the one or more machine learning models.

The one or more machine learning models may be configured (e.g., trained) to generate, using a style encoder of the one or more machine-learning models, one or more style embeddings representing nonverbal characteristics of the audio data and generate, using a linguistic encoder of the one or more machine-learning models, one or more linguistic embeddings representing textual content of the audio data. In some examples, the one or more style embeddings represent one or more attributes, such as speaker identity, gender, emotion, accent, tone, speech rate, health state, age, vocal pitch, vocal intensity, and/or cognitive state. Embeddings, as used herein, may refer to lower dimensional representations of the input audio data that capture rich semantic information about the audio data.

In some examples, process 200 includes generating one or more supplementary style embeddings based on the one or more style embeddings. The one or more supplementary style embeddings may include information-rich portions of the input audio data. In some examples, process 200 includes generating one or more supplementary linguistic embeddings based on the one or more linguistic embeddings. The one or more supplementary linguistic embeddings may also include information-rich portions of the input audio data. The supplementary style embeddings and/or supplementary linguistic embeddings may be generated using one or more attentive statistics pooling (ASP) layers and/or one or more multi-layer perceptron (MLP) networks of the one or more machine learning models (which may be referred to herein as attentive statistics pooling+multi-layer perceptron modules). The style embeddings' and/or linguistic embeddings' dimensions may be reduced using the attentive statistics pooling (ASP) layer and/or the multi-layer perceptron (MLP) network. The ASP layers and MLP networks may be trained using binary cross-entropy loss. In some examples, the ASP layers and MLP networks may be trained jointly with a classification head, as described further below.

In some examples the one or more machine learning models are configured (e.g., trained) to determine one or more dependency embeddings representing dependencies between the one or more style embeddings and the one or more linguistic embeddings. Determining a first subset of the one or more dependency embeddings may include inputting the one or more style embeddings into a style compressor and compressing the one or more style embeddings to create one or more style dependency embeddings. Determining a second subset of the one or more dependency embeddings may include inputting the one or more linguistic embeddings into a linguistic compressor and compressing the one or more linguistic embeddings to create one or more linguistic dependency embeddings. The style compressor may include one or more neural network layers configured to decrease redundant information and produce compressed style embeddings, which may be referred to herein as style dependency embeddings or style dependency features. The linguistic compressor may include one or more neural network layers configured to decrease redundant information and produce compressed linguistic embeddings, which may be referred to herein as linguistic dependency embeddings or linguistic dependency features.

In some examples the style compressor and the linguistics compressor have been trained to minimize a difference between the one or more style dependency embeddings and the one or more linguistic dependency embeddings. Training the style compressor and the linguistics compressor to minimize a difference between the one or more style dependency embeddings and the one or more linguistic dependency embeddings may include inputting bona fide audio data into the style encoder of the machine-learning model and the linguistic encoder of the one or more machine-learning models; generating one or more style embeddings representing nonverbal characteristics of the audio data using the style encoder of the one or more machine learning models; generating one or more linguistic embeddings representing textual content of the audio data using the linguistic encoder of the one or more machine learning models; inputting the one or more style embeddings into the style compressor; compressing the one or more style embeddings to create one or more style dependency embeddings; inputting the one or more linguistic embeddings into the linguistic compressor; compressing the one or more linguistic embeddings to create one or more linguistic dependency embeddings; and updating one or both of the style compressor and the linguistic compressor to minimize a difference between style dependency embeddings and linguistic dependency embeddings generated using the style compressor and the linguistic compressor. The style compressor and/or the linguistics compressor have been trained to minimize a difference between the one or more style dependency embeddings and the one or more linguistic dependency embeddings, for instance, by training the style compression module and/or the linguistics compression module to minimize a self-contrastive loss. The style compression module and/or the linguistics compression module have been trained via self-supervised learning using bona fide audio data comprising real human speech.

At block 204, process 200 may include inputting the one or more dependency embeddings into a classification head of the one or more machine learning models, wherein the classification head has been trained to classify the audio data as real or fake. The classification head may have been trained to classify audio as real or fake via supervised learning using labeled audio data. The classification head may include two fully-connected layers and a dropout layer. The classification head may have been jointly trained alongside the ASP layers and/or MLP networks described above. In some examples, the one or more supplementary style embeddings, one or more supplementary linguistic embeddings, one or more style dependency embeddings, and one or more linguistic dependency embeddings are concatenated to one another, and the concatenated embeddings are input into the classification head. For instance, because the dependency embeddings (one or more style dependency embeddings, and one or more linguistic dependency embeddings) are designed to capture dependencies between style and linguistics in the input audio data, the dependency embeddings may be complemented with the supplementary style embeddings and/or the supplementary linguistic embeddings in order to capture other artifacts that can help separate real samples from the fake class. In some examples, the style embeddings and/or linguistic embeddings (e.g., the original style embeddings and/or linguistic embeddings as opposed to the supplementary style or linguistic embeddings) may be concatenated to the dependency embeddings and input into the classification module.

At block 206, process 200 may include obtaining, from the trained one or more machine-learning models, a classification result of whether the audio data is real or fake. In some examples, process 200 may include restricting access to a computing resource or protected endpoint based on a classification result indicating that the audio is fake. For instance, process 200 may include generating a signal in response to a classification result that indicates the audio data is fake. The signal may be transmitted to an access control subsystem, which in turn may restrict a user's or device's access to one or more protected endpoints (e.g., secure servers, cloud storage resources, or restricted application programming interfaces). This restriction can be enforced by revoking credentials, invalidating session tokens, or instituting additional authentication steps (e.g., two-factor authentication) to ensure that only legitimate users are granted access to the protected resource. In some examples, process 200 may include displaying an alert via a user interface based on a classification result indicating that the audio is fake. For instance, process 200 may include generating a notification payload containing metadata associated with the classification result (e.g., confidence score, timestamp, or source identifier), which is then sent to a user interface. The user interface may display the alert (e.g., a pop-up message, warning dialog, or visual indicator) that states the audio has been classified as fake/synthetic, optionally prompting a user or administrator to take corrective action, such as terminating a call or initiating a security investigation.

Process 200 may thus be implemented for various practical purposes. Real-time recognition of synthetic/deepfake audio can help prevent unauthorized parties from impersonating valid participants in virtual meetings. By detecting and isolating/blocking suspicious, organizations can enhance communication security and protect sensitive information. Restricting account access when a fraudulent audio command is detected can significantly reduce the risk of attacks on financial institutions. Alerting customer service agents to synthetic/deepfake audio inputs can help preserve the integrity of voice-based verification processes. When an alert is triggered, agents may employ additional identity checks to maintain robust authentication procedures for call center operations. Detecting and denying synthetic/deepfake audio commands in critical infrastructure control systems can prevent malicious entities from manipulating industrial or governmental operations.

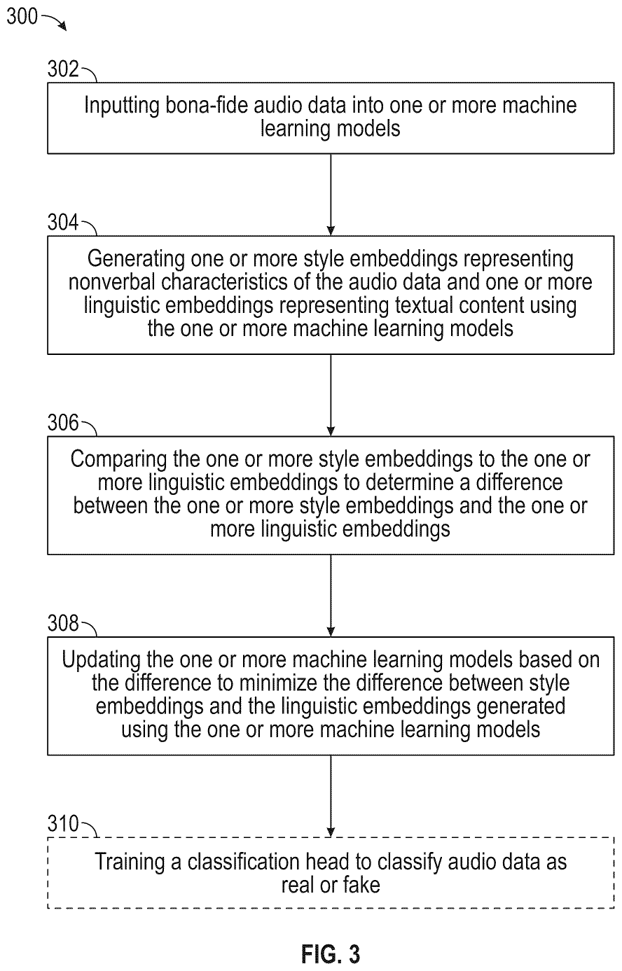

FIG. 3 illustrates aspects of an exemplary process 300 for training one or more machine learning models to learn dependencies between style and linguistics in bona fide audio. Process 300 may be performed using one or more aspects of system 100 and any one or more of the aspects of training process 300 and/or model components described with reference to process 300 may be performed to train one or more of the machine learning models and/or used as a component of the one or more machine learning models of process 200. Any or all of the aspects of process 300 may be used to train the one or more machine learning models of system 100 and/or process 200.

Process 300 is performed, for example, using one or more electronic devices implementing a software platform. In some examples, process 300 is performed using a client-server system, and the blocks of process 300 are divided up in any manner between the server and a client device. In other examples, the blocks of process 300 are divided up between the server and multiple client devices. Thus, while portions of process 300 may be described herein as being performed by particular devices of a client-server system, it will be appreciated that process 300 is not so limited. In other examples, process 300 is performed using only a client device or only multiple client devices. In process 300, some blocks are, optionally, combined, the order of some blocks is, optionally, changed, and some blocks are, optionally, omitted. In some examples, additional steps may be performed in combination with the process 300. Accordingly, the operations as illustrated (and described in greater detail below) are exemplary by nature and, as such, should not be viewed as limiting.

At block 302, process 300 may include inputting bona fide audio data into the one or more machine learning models. The bona fide audio data may include real human speech. The bona fide audio data may not include any synthetic/deepfake human speech. Using only bona fide audio data with real human speech may enable the one or more machine learning models to learn dependencies between style and linguistics in real human speech, which may be distinct from the relationship between style and linguistics in synthetic/deepfake human speech.

At block 304, process 300 may include generating one or more style embeddings representing nonverbal characteristics of the audio data and one or more linguistic embeddings representing textual content using the one or more machine learning models. In some examples, the bona fide audio data may be input into a first encoder and a second encoder. Copies of the same bona fide audio data may be processed in parallel (e.g., separately, optionally at the same time) using the first encoder and second encoder. The first encoder may be a “style” encoder trained to generate style embeddings representing nonverbal features of the bona fide audio data. The second encoder may be a “linguistic” encoder trained to generate linguistic embeddings representing textual (e.g., verbal) content of the bona fide audio data. In some examples, style embeddings generated using the first encoder may be processed using a style compressor and the linguistic embeddings generated using the second encoder may be processed using a linguistic compressor. The style compressor may include one or more neural network layers configured to decrease redundant information and produce compressed style embeddings, which may be referred to herein as style dependency embeddings or style dependency features. The linguistic compressor may include one or more neural network layers configured to decrease redundant information and produce compressed linguistic embeddings, which may be referred to herein as linguistic dependency embeddings or linguistic dependency features.

At block 306, process 300 may include comparing the one or more style embeddings to the one or more linguistic embeddings to determine a difference between the one or more style embeddings and the one or more linguistic embeddings. At block 308, process 300 may include updating the one or more machine learning models based on the difference to minimize the difference between style embeddings and the linguistic embeddings generated using the one or more machine learning models. For instance, a cross-subspace loss may be determined between the style dependency embeddings and the linguistic dependency embeddings. The cross-subspace loss may be used to encourage the one or more machine learning models to minimize the distance between the style dependency embeddings and the linguistic dependency embeddings. An intra-subspace loss may be used to reduce redundancy within (temporally averaged) style dependency embeddings and linguistic dependency embeddings, which may ensure the style dependency embeddings and linguistic dependency embeddings capture sufficiently distinct information.

Blocks 302-308 may represent aspects of a first, self-supervised, training stage. At block 310, process 300 may include a second, supervised training stage, which may include training a classification head to classify audio data as real or fake. During the second training stage at block 310, the first encoder, second encoder, style compressor, and linguistic compressor may be “frozen” (i.e., these components of the one or more machine learning models may not be updated/retrained/finetuned or otherwise changed). At block 310, labeled deepfake and/or bona fide audio samples may be input into the first encoder and the second encoder. The same labeled audio samples may be input into each of the first encoder and the second encoder. The first encoder may generate one or more style embeddings representing nonverbal features of the one or more labeled audio samples. The one or more style embeddings may be input into the style compressor and the style compressor may generate one or more style dependency embeddings (i.e., style dependency features). A copy of the one or more style embeddings generated by the first encoder may also be input into one or more attentive statistics pooling layers and multi-layer perceptron networks. The attentive statistics pooling layers and multi-layer perceptron networks may reduce the dimensionality of the one or more style embeddings to generate one or more supplementary style embeddings that match the dimensionality of the one or more style dependency embeddings.

The second encoder may generate one or more linguistic embeddings representing textual (e.g., verbal) content of the one or more labeled audio samples. The one or more linguistic embeddings may be input into the linguistic compressor and the linguistic compressor may generate one or more linguistic dependency embeddings (i.e., linguistic dependency features). A copy of the one or more linguistic embeddings generated by the second encoder may also be input into one or more attentive statistics pooling layers and multi-layer perceptron networks. The attentive statistics pooling layers and multi-layer perceptron networks may reduce the dimensionality of the one or more linguistic embeddings to generate one or more supplementary linguistic embeddings that match the dimensionality of the one or more linguistic dependency embeddings.

The one or more style dependency embeddings, one or more supplementary style embeddings, one or more linguistic dependency embeddings, and one or more supplementary linguistic embeddings may be concatenated to produce a concatenated vector input for the classification head. The classification head may be trained to classify the concatenated vector input as real (e.g., bona fide audio) or fake (e.g., deepfake audio). The classification head may include, for instance, two fully-connected layers and a dropout layer. The classification head may be trained via a binary cross-entropy loss. The attentive statistics pooling layers and multi-layer perceptron networks may be jointly trained with the classification head using the binary cross-entropy loss.

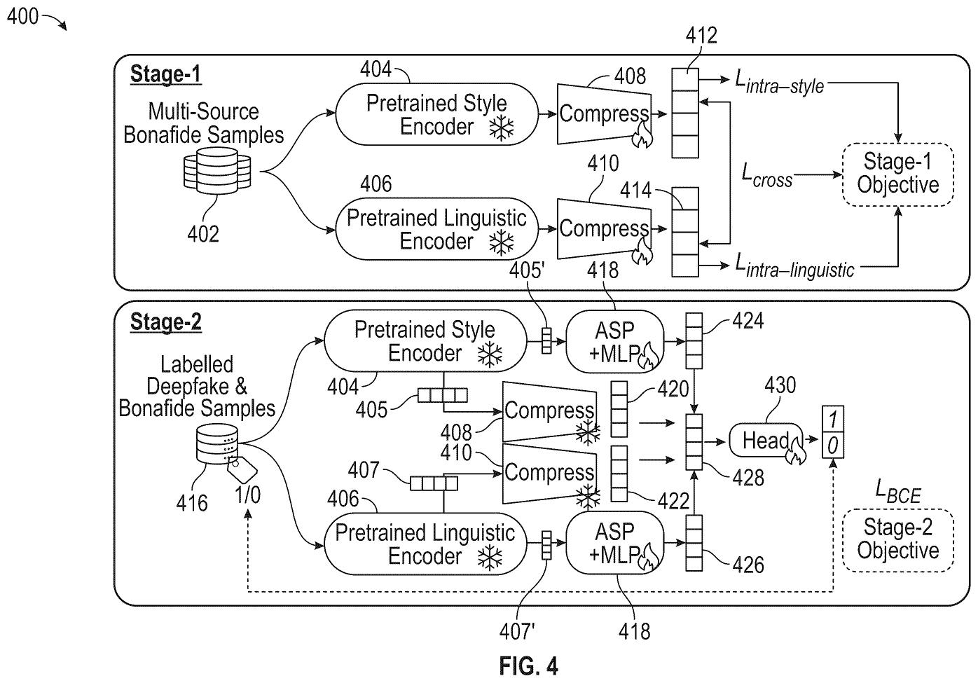

FIG. 4 illustrates a schematic diagram depicting aspects of a two-stage training process 400 for training one or more machine learning models to classify audio as real or fake. Process 400 may include any of the aspects of processes 200 and/or 300 described above and may be performed using one or more elements of system 100. Any or all of the aspects of process 400 may be used to train the one or more machine learning models of system 100 and/or process 200, optionally in combination with any of the aspects of process 300.

Process 400 is performed, for example, using one or more electronic devices implementing a software platform. In some examples, process 400 is performed using a client-server system, and the blocks of process 400 are divided up in any manner between the server and a client device. In other examples, the blocks of process 400 are divided up between the server and multiple client devices. Thus, while portions of process 400 may be described herein as being performed by particular devices of a client-server system, it will be appreciated that process 400 is not so limited. In other examples, process 400 is performed using only a client device or only multiple client devices. In process 400, some blocks are, optionally, combined, the order of some blocks is, optionally, changed, and some blocks are, optionally, omitted. In some examples, additional steps may be performed in combination with the process 400. Accordingly, the operations as illustrated (and described in greater detail below) are exemplary by nature and, as such, should not be viewed as limiting.

The objective of the first training stage is to learn pairs of dependency features from style and linguistics subspaces, which are expected to be highly correlated for real samples and minimally correlated for deepfakes. An exemplary system performing process 400 may only use real/bona fide audio samples as training data for the first training stage. Accordingly, open-source speech datasets may be incorporated into the training data to diversify the style variations. During the first training stage, the exemplary system (e.g., one or more electronic devices) performing process 400 may input one or more bona fide audio samples 402 from one or more sources into a first encoder 404 and a second encoder 406. The one or more bona fide audio samples may include real human speech. The bona fide audio data may not include any synthetic/deepfake human speech. Using only bona fide audio data with real human speech may enable the one or more machine learning models to learn dependencies between style and linguistics in real human speech, which may be distinct from the relationship between style and linguistics in synthetic/deepfake human speech.

Copies of the same bona fide audio sample may be input into both the first encoder 404 and the second encoder 406. The copies of the same bona fide audio sample may be processed in parallel (e.g., separately, optionally at the same time) using the first encoder 404 and the second encoder 406. The first encoder 404 may be a pretrained encoder and may be trained to generate one or more style embeddings based on the input bona fide audio sample (e.g., referred to as a “style encoder” herein). The one or more style embeddings may represent nonverbal content included in the audio sample, for instance, including attributes such as speaker identity, gender, emotion, accent, tone, speech rate, health state, age, vocal pitch, vocal intensity, and/or cognitive state. The second encoder 406 may be a pretrained encoder and may be trained to generate one or more linguistic embeddings based on the input bona fide audio sample (e.g., referred to as a “linguistic encoder” herein). The one or more linguistic embeddings may represent textual (e.g., verbal) content included in the audio sample. In some examples, the first encoder 404 and the second encoder 406 are frozen (i.e., may not be updated or trained) during the two-stage training process 400.

The style embeddings generated using the first encoder may be referred to herein as X_{S} and the linguistic embeddings generated using the second encoder may be referred to herein as X_{L}. The style embeddings and the linguistic embeddings may each be three-dimensional tensors ∈R^{K×F×T} where K denotes the transformer layer index, F denotes the feature size, and T denotes the number of time steps. The one or more style embeddings X_{S} generated using the first encoder 404 may be input into a first compressor 408. The first compressor 408 may average the transformer layer outputs (of the first encoder 404) and reduce the feature size of X_{S} (e.g., from 1024 to 256). The one or more linguistic embeddings X_{L} generated using the second encoder 406 may be input into a compressor module 410. The second compressor 410 may likewise average the transformer layer outputs (of the second encoder 406) and reduce the feature size of X_{L} (e.g., from 1024 to 256). The output 412 of the first compressor 408 may be referred to herein as style dependency embeddings or style dependency features, S_{f,t}=C(X_{S}), and their temporally averaged versions S̅_{f,t}. The output 414 of the second compressor 410 may be referred to herein as linguistic dependency embeddings or linguistic dependency features, L_{f,t}=C(X_{L}), and their temporally averaged versions L̅_{f,t}. These dependency features are learned by minimizing the self-contrastive loss L_{con}, defined as:

$${ℒ}_{con} = {ℒ}_{cross} + {λℒ}_{intra} , {ℒ}_{intra} = {ℒ}_{style} + {ℒ}_{linguistics} \qquad ( 1 )$$

$${ℒ}_{cross} = \frac{1}{T} {\sum }_{t = 0}^{T} {‖ {S}_{f , t} - {L}_{f , t} ‖}_{F}^{2} , {ℒ}_{intra} = {‖ {\overline{S}}_{f} {\overline{S}}_{f}^{T} - 𝕀 ‖}_{F}^{2} + {‖ {\overline{L}}_{f} {\overline{L}}_{f}^{T} - 𝕀 ‖}_{F}^{2} \qquad ( 2 )$$

L_{cross} denotes the cross-subspace loss; Lᵢₙₜᵣₐ is the intra-subspace loss, defined in terms of L_{style} and L_{linguistics} (FIG. 1); λ∈[0, 1] is a hyperparameter that weighs the two loss terms, Tis the number of time steps; and ∥(·)∥_{F}² is the Frobenius norm. The L_{cross} term reduces distance between the compressed style and linguistic embeddings, while the Lᵢₙₜᵣₐ term reduces redundancy within the (temporally averaged) style and linguistic features by pushing off-diagonal elements to zero. The learned dependency features from the first training stage can be used to quantify whether a mismatch exists between the style and linguistics of an audio input.

During the second training stage, the first encoder 404, second encoder 406, first compressor 408, and second compressor 410 may be “frozen” (i.e., these modules/models may not be updated/retrained/finetuned or otherwise changed). Labeled deepfake and/or bona fide audio samples 416 may be input into the first encoder 404 and the second encoder 406. The same labeled audio samples 416 may be input into each of the first encoder 404 and the second encoder 406. The first encoder 404 may generate one or more style embeddings 405 representing nonverbal features of the one or more labeled audio samples 416. The one or more style embeddings 405 may be input into the first compressor 408 and the first compressor 408 may generate one or more style dependency embeddings 420 (i.e., style dependency features). A copy of the one or more style embeddings 405′ generated by the first encoder 404 may also be input into one or more attentive statistics pooling layers+multi-layer perceptron networks 418. The attentive statistics pooling layers+multi-layer perceptron networks 418 may reduce the dimensionality of the one or more style embeddings 405′ to generate one or more supplemental style embeddings 424 that match the dimensionality of the one or more style dependency embeddings 420. The second encoder 406 may generate one or more linguistic embeddings 407 representing textual (e.g., verbal) content of the one or more labeled audio samples 416. The one or more linguistic embeddings may be input into the second compressor 410 and the second compressor 410 may generate one or more linguistic dependency embeddings 422 (i.e., linguistic dependency features). A copy of the one or more linguistic embeddings 407′ generated by the second encoder 406 may also be input into one or more attentive statistics pooling layers+multi-layer perceptron networks 418. The attentive statistics pooling layers+multi-layer perceptron networks 418 may reduce the dimensionality of the one or more linguistic embeddings to generate one or more supplemental linguistic embeddings 426 that match the dimensionality of the one or more linguistic dependency embeddings 422.

The one or more style dependency embeddings 420, one or more supplemental style embeddings 424, one or more linguistic dependency embeddings 422, and one or more supplemental linguistic embeddings 426 may be concatenated to produce a concatenated vector input 428 for the classifier module 430. The classification head 430 may be trained to classify the concatenated vector input 428 as real (e.g., bona fide) or fake (e.g., a deepfake). The classification head 430 may include, for instance, two fully-connected layers and a dropout layer. The classification head 430 may be trained via a binary cross-entropy loss. The attentive statistics pooling layers+multi-layer perceptron networks 418 may be jointly trained with the classifier module 430 using the binary cross-entropy loss.

### Exemplary Methods

A mismatch is hypothesized to exist between style and linguistics information in deepfakes, which would help differentiate them from real speech. The following description provides a proof-of-concept experiment to validate this hypothesis with a small dataset. Using Canonical Correlation Analysis (CCA), the dependency between style and linguistics embeddings can be quantified by obtaining the maximal correlations between their linear projections, which has been previously used for estimating the similarity between embeddings with different feature lengths. The last layer output was chosen from the wav2vec2-large-xlsr-53-english backbone and pretrained ECAPA-TDNN embeddings as the linguistics and speaker representations, respectively. To align the number of dimensions between the two subspaces, temporal average pooling was applied to the linguistics embeddings. For fitting the CCA models, 100 bonafide speech samples were randomly selected from one speaker from the ASVspoof2019 training set; both the linguistics and style features were then linearly projected to 20-dim vectors. During evaluation, 200 samples were selected from 5 unseen speakers (a total of 1000 samples) from each class (bonafide+4 TTS+2 VC) and applied the fitted CCA models. The Pearson correlation coefficient (r) was then calculated between the projected vectors to quantify the similarity between subspaces.

Table 1 shows the similarity between CCA-projected style and linguistics embeddings. In line with the hypothesis, a higher similarity is seen with bonafide speech, whereas significantly lower similarities are observed for both TTS and VC generated samples. Moreover, TTS-samples on average show lower r (0.228) than VC-samples (0.236), indicating that VC-samples are closer to real speech in terms of linguistics-style dependency. Such finding also corroborates with the summarized findings of the ASVspoof2019 challenge where VC-samples were shown to be more challenging to detect than TTS-samples [35]. Overall, a significantly higher agreement was found between the projected style and linguistic embeddings for real speech than for TTS and VC generated ones, suggesting a higher subspace mismatch in deepfakes. Therefore, a detection framework that explicitly studies the style-linguistics mismatch and scales to larger amount of data was developed according to the techniques described herein.

TABLE 1
Pearson correlation coefficients calculated between style
and linguistics embeddings for bonafide and TTS/VC
generated samples from the ASVspoof2019 training set.
Lower values suggest less similarity. Significant
difference is seen between bonafide speech and
all types of generated speech.

| | | | | | A04 | | |
|---|---|---|---|---|---|---|---|
| | Bo- | A01 | A02 | A03 | TTS- | A05 | A06 |
| Class | nafide | TTS-01 | TTS-02 | TTS-03 | 04 | VC-01 | VC-02 |
| Similarity | .308 | .202 | .217 | .243 | .253 | .214 | .252 |
| (r) | +/− | +/− | +/− | +/− | +/− | +/− | +/− |
| | 0.25 | 0.33 | 0.20 | 0.24 | 0.21 | 0.26 | 0.20 |

While the style-linguistics mismatch could possibly be learned via a supervised contrastive approach with labelled data, the learned mismatch may be biased by the limited number of deepfakes used for training, and might face issues when generalizing to unseen attacks. Instead, only bonafide speech samples were used to learn a pair of maximally correlated dependency features from style and linguistics representations, where the mismatch can be quantified by the distance between the learned feature pairs. The overall framework of SLIM is depicted in FIG. 1, which has two training stages with different objectives.

### Stage-1: One-Class Self-Supervised Contrastive Training

The goal of the first stage is to learn a pair of dependency features from style and linguistics subspaces, which are expected to be highly correlated for bonafide samples and minimally correlated for deepfakes. Since only bonafide samples are needed, training is not constrained by deepfake datasets, hence other open-source speech datasets were incorporated to diversify the style variations. Given a speech sample, the style and linguistics representations were extracted separately using pretrained networks. Given the recent success of large speech models on multiple speech downstream tasks, a group of SSL models fine-tuned for paralinguistics and linguistics tasks were selected as candidate encoders. Ideally, one representation should contain minimal information about the other subspace (i.e., disentangled), but such disentanglement is not yet clear for SSL representations. Inspired by recent works that showed how different speech information propagates through the transformer layers, a similar layer-wise analysis of the selected candidate representations can be performed to determine what backbones and layers to use. Layer 0-10's output from Wav2vec-XLSR fine-tuned for speech emotion recognition to was chosen represent style, and layer 14-21's output from the Wav2vec-XLSR fine-tuned for automatic speech recognition, to represent linguistics information.

Both style and linguistics embeddings are three-dimensional tensors X∈R^{L×F×T} where L denotes the transformer layer index, F denotes the embedding size, and T denotes the number of time steps.

These subspace embeddings are sent into compression modules, which average layer outputs then reduce the feature size from 1024 to 256. Detailed architecture of the compression module is given in the Appendix. The output from compression modules are called dependency features (referred to above with reference to FIGS. 1-3 as dependency embeddings), denoted as S_{f,t} and L_{f,t} for style and linguistics. These dependency features are learned via a self-contrastive objective, defined as follows:

$${L}_{stage 1} = {L}_{cross} + λ {L}_{intra} \qquad ( 1 )$$

$${ℒ}_{cross} = \frac{1}{T} {\sum }_{t = 0}^{=} {‖ {\overline{S}}_{f , t} - {L}_{f , t} ‖}_{F}^{{2}^{tT}} \qquad ( 2 )$$

$${ℒ}_{intra} = {‖ {\overline{S}}_{f , t} {\overline{S}}_{f , t}^{T} - 𝕀 ‖}_{F}^{2} + {‖ {\overline{L}}_{f , t} {\overline{L}}_{f , t}^{T} - 𝕀 ‖}_{F}^{2} \qquad ( 3 )$$

The overall objective L_{stage1} comprises two parts: the cross-subspace loss and the intra-subspace loss. The cross-subspace loss L_{cross} is a summation of the Frobenius norm of the distance between S̅_{f,t} and L_{f,t} at each time step, where S̅_{f,t} is a temporally averaged style vector. By minimizing the cross-subspace loss, the two compressed subspace embeddings can be maximally correlated. The intra-subspace loss Lᵢₙₜᵣₐ penalizes feature redundancy of the two temporally averaged dependency features by pushing off-diagonal elements to zero. λ is a hyper-parameter that balances the two terms. Together, the learned dependency features can be used to quantify whether a mismatch exists between style and linguistics aspects.

### Stage-2: Supervised Training

The second stage of SLIM follows a standard supervised training scheme, where the output embeddings from four branches are fused, then fed into a classification head to generate the final decision. As shown in FIG. 4, the subspace SSL encoders and compression modules remain the same as those used in stage-1, which are all frozen during stage-2. Since dependency features are designed to capture the style-linguistics mismatch, deepfake artifacts/imperfections might be neglected. This is complemented by projecting subspace embeddings X to 256-dim feature vectors through a combination of an attentive statistics pooling (ASP) layer and a multi-layer perceptron (MLP). The projected subspace embeddings are concatenated with dependency features, resulting in a 1024-dim vector. The classification head consists of two fully-connected layers and a dropout layer. The ASP+MLP modules are jointly updated with the classification head using a binary cross-entropy loss.

### Experiments

Based on the preliminary results described above, the in-domain and cross-domain detection performance of SLIM using multiple datasets were systemically assessed to demonstrate how such a framework would benefit the interpretation of model decisions.

### Experimental Setup

Training and evaluation data: Models are evaluated with four deepfake datasets: ASVspoof2019 LA, ASVspoof2021 DF, In-the-wild, and the English subset from MLAAD v3. ASVspoof2019 LA and ASVspoof2021 DF have been used as standard datasets for evaluating deepfake detection models, where bonafide speech recordings originate from the VCTK and VCC datasets and the spoofed ones are generated with a variety of TTS and VC systems. Compared to ASVspoof2019 LA, ASVspoof2021 DF contains more than 100 different types of generated speech in the evaluation set, providing a more stringent setting for testing generalization to unseen attacks. In-the-wild is based on audio clips collected from English-speaking celebrities and politicians, featuring more realistic and spontaneous speech samples. The English subset of MLAAD (hereinafter referred to as MLAAD-EN) is a recent dataset with spoofed samples generated by state-of-the-art open-source TTS and VC systems. Further details about these datasets can be found in the Appendix. For a fair comparison with other works, the standard training-testing partition was adopted where only the ASVspoof2019 logical access (LA) training and development set are used for training and validation, while all the rest (i.e., ASVspoof2019 LA eval, ASVspoof2021 DF eval, In-the-wild, and MLAAD-EN) is used for testing.

Stage-1 training data: Different from benchmark models which are trained end-to-end in a supervised manner, the SLIM model relies on a two-stage training where each stage uses different training data to avoid information leakage. Since only bonafide samples are needed in stage-1, advantage was taken of open-source speech datasets by aggregating subsets from the Common Voice and RAVDESS as training data and use a small portion of bonafide samples from the ASVspoof2019 LA train for validation. Both Common Voice and RAVDESS cover a variety of speaker traits. The former is a crowdsourced dataset collected online from numerous speakers with uncontrolled acoustic environments, while the latter is an emotional speech corpus with large variations in prosodic patterns. Such data variety enables the model to learn a wider range of linguistics-style combinations.

Metrics: Equal Error Rate (EER) has been commonly adopted as a standard metric for evaluating deepfake detection performance. It refers to the point in the detection error tradeoff curve where the false acceptance rate equals the false rejection rate, hence lower EER values suggest better detection performance. Since the detection task is a binary classification task, F1 scores were also reported to account for the class imbalance, where higher values suggest better performance.

Benchmarks: Recent SOTA models rely on pretrained SSL frontends appended with different backend classifiers. They were divided into two categories based on the training cost: (1) the ones that freeze frontends and fine-tune only backend classifiers, and (2) the ones that fine-tune frontends together with classifiers during supervised training. For the former, Wa2vecXLSR+LLGF (W2V-LLGF), Wav2vec-XLSR+LCNN (W2V-LCNN), six self-customized models that share a similar backend classifier (ASP+MLP) as SLIM (W2V/WLM/HUB-ASP), a model that fuses different SSL representations (SSL-fusion), as well as the ones that do not rely on SSL encoders (LCNN, RawNet2, CVNN, PS3DT) were included. For the latter, a model with a backend classifier similar to SLIM's (W2V-ASP-ft), and a model with a more complicated backend (W2V-AASIST) with RawBoost augmentation were selected. When comparing to the benchmarks in the frozen frontend category, five variants of SLIM were implemented based on the input at stage-2, namely inputting only the style embeddings, only the linguistics embeddings, the combination of style and linguistics, only the style-linguistics dependency features, and the fusion of subspace embeddings and dependency features. It should be emphasized that the original SLIM does not involve any fine-tuning of frontends, since the fine-tuning may change the disentanglement of style and linguistics embeddings, hence hampering the model explainability. Notwithstanding, for fair comparison with the benchmarks in the fine-tuning category, a variant of SLIM that fine-tunes all modules during stage-2 was implemented.

Implementation details. The models were implemented using the SpeechBrain toolkit version 1.0.0. The hyperparameters used for stage-1 and stage-2 training are provided in the Appendix. When setting up the customized benchmark models, the same training recipes where only the model architectures were changed and the same data augmentation method was used were followed. Each round of evaluation was repeated three times with different random seeds, the mean values are reported.

### Experiment Results

In-domain and out-of-domain detection performance. Table 2 and Table 2.1 summarize the detection performance of the compared models along with the number of trainable parameters. ASVspoof2019 evaluation set contains 19 different types of attacks, where 6 were seen during training. This makes it the simplest case among the four, where the majority of the models performs near perfectly, with several including SLIM obtaining EER below 1%. As expected, degradation is seen when models are tested on unseen attacks. With ASVspoof2021, models that fine-tune SSL frontend on ASVspoof2019 perform significantly better than the rest that rely on a frozen frontend (including SLIM). With In-the-wild and MLAAD datasets, more severe degradation has been observed, where the majority obtains EER over 20%. With these two out-of-domain datasets, SLIM largely exceeds the others with EER of 12.9% and 13.5% achieved respectively. It should be noted that although ASVspoof2021 is often used as a standard dataset to evaluate model generalizability to unseen attacks, part of the bonafide samples in ASVspoof2021 originate from the same dataset (the VCTK corpus) as the ASVspoof2019 training data. As a result, it was found that embeddings of the bonafide samples from ASVspoof2019 and ASVspoof2021 share similar distributions, whereas the distributions of In-the-wild and MLAAD samples share nearly no overlap with the ASVspoof ones. This suggests that the generalization to In-the-wild and MLAAD is more challenging than to ASVspoof 2021. Notwithstanding, SLIM significantly outperforms the others without the need for fine-tuning SSL frontend, demonstrating that it is an effective yet low-cost approach for improving generalizability.

To further investigate the necessity of the stage-1 self-supervised training, the performance achieved by different features fused at stage-2 was compared (bottom 4 rows in Table 2), namely the dependency features, the style and linguistics embeddings, as well as their combinations. For a fair comparison, the architecture of the classification head remains the same, except for the number of neurons in the input layer. The dependency features are found to outperform the rest on the two out of-domain datasets, while the subspace embeddings perform better on ASVspoof2021. Additionally, simply concatenating the style and linguistics embeddings does not bring significant improvement, which indicates that the style-linguistics dependency may not be captured by supervised training when no explicit guidance is provided.

TABLE 2
Detection performance achieved with deepfake datasets and bonafide-only datasets. All
models are trained only with ASVspoof2019 LA train. Experiments were repeated three times with
different random seeds, and average metric values are reported. Some benchmarks do not have
their code open-source; the numbers here are from their papers. #Param refers to the number of
trainable parameters (in millions).

| Cate- | | ASVspoof19 | | ASVspoofs21 | | in-the-wild | | MLAAD-EN | | #Param | [symbol] |
|---|---|---|---|---|---|---|---|---|---|---|---|
| gory | Model | EER↓ | F1↑ | EER↓ | F1↑ | EER↓ | F1↑ | EER↓ | F1↑ | [symbol] | [symbol] |
| | LCNN [13] | 3.7 | [symbol] | 25.5 | .197 | 65.6 | .373 | | | | [symbol] |
| | RawNet2 [53] | 3.0 | .875 | 22.3 | .213 | 37.8 | .602 | | | | [symbol] |
| | CVNN [44] | — | — | — | — | 26.6 | — | — | — | N/A | [symbol] |
| | PS3DT [67] | 4.5 | — | — | — | 29.7 | — | — | —— | N/A | [symbol] |
| Frozen | W2V-ASP | 3.3 | .858 | 15.8 | .283 | 30.2 | .705 | 29.1 | .715 | 9 | [symbol] |
| front- | WLM-ASP | 0.3 | .983 | 9.0 | .426 | 25.4 | .751 | 30.3 | .709 | 9 | [symbol] |
| end | HUB-ASP | 0.5 | .975 | 15.4 | .289 | 29.9 | .718 | 51.0 | .702 | 9 | [symbol] |
| | WZV-LLGP | 2.3 | .936 | 9.4 | .402 | 25.1 | .756 | 27.8 | .731 | 10 | [symbol] |
| | [61] | | | | | | | | | | |
| | WZV-LCNN | 0.6 | — | 6.1 | — | 24.5 | — | — | — | N/A | [symbol] |
| | [65] | | | | | | | | | | |
| | WZV + WLM | 1.8 | .916 | 22.5 | .203 | 30.3 | .704 | 27.0 | .739 | 9 | [symbol] |
| | WZV + HUB | 0.9 | .956 | 14.2 | .510 | 27.9 | .737 | 27.6 | .732 | 9\| | [symbol] |
| | WEM + HUS | 0.8 | .963 | 16.7 | .289 | 29.2 | .724 | 28.5 | .720 | 9 | [symbol] |
| | SSL-Fusion [71] | 0.3 | .981 | 8.9 | .419 | 24.2 | .765 | 26.5 | .739 | 10 | [symbol] |
| | SLIM variants | | | | | | | | | | |
| | [symbol] | 6.7 | .740 | 8.6 | .438 | 29.2 | .724 | 25.4 | .756 | 9 | ✓ |
| | [symbol] | 5.9 | .764 | 9.5 | .407 | 30.4 | .706 | 25.0 | .760 | 9 | ✓ |
| | [symbol] | 3.5 | .834 | 9.0 | .429 | 25.1 | .757 | 23.9 | .772 | 10 | [symbol] |
| | Dependency | 2.8 | .897 | 20.5 | .234 | 25.8 | .750 | 19.8 | .811 | 9 | ✓ |
| | Full | 0.6 | .969 | 8.3 | .451 | 12.9 | .895 | 15.5 | .865 | 11 | ✓ |
| | W2V-ASP [59] | 0.5 | .984 | 4.5 | | 15.5 | .835 | 19.2 | .317 | 317 | [symbol] |
| Fine- | W2V-AA515T | 0.2 | .991 | 3.6 | | 17.5 | .847 | 14.5 | .856 | 317 | [symbol] |
| tuned | [55] | | | | | | | | | | |
| front- | SLIM | | | | | | | | | 255 | [symbol] |
| end | | | | | | | | | | | |

[symbol]

indicates data missing or illegible when filed

TABLE 2.1
Detection performance on different deepfake datasets. Experiments were repeated three
times with different random seeds, and average metric values are reported.

| Cate- | | ASVspoof19 | | ASVspoof21 | | In-the-wild | | MLAAD-EN | | #Param |
|---|---|---|---|---|---|---|---|---|---|---|
| gory | Model | EER↓ | F1↑ | EER↓ | F1↑ | EER↓ | F1↑ | EER↓ | F1↑ | (million) |
| | LCNN [12] | 3.7 | .834 | 25.5 | .197 | 65.6 | .373 | 37.2 | .654 | 4 |
| | RawNet2 [69] | 3.0 | .875 | 22.3 | .213 | 37.8 | .602 | 33.9 | .676 | 4 |
| | PS3DT [88] | 4.5 | — | — | — | 29.7 | — | — | — | N/A |
| | W2V-ASP | 3.3 | .858 | 19.6 | .233 | 30.2 | .705 | 29.1 | .715 | 9 |
| | WLM-ASP | 0.3 | .983 | 9.0 | .426 | 25.4 | .751 | 30.3 | .709 | 9 |
| | HUB-ASP | 0.5 | .975 | 15.4 | .289 | 29.9 | .718 | 31.0 | .702 | 9 |
| Frozen | W2V-LLGF [81] | 2.3 | .936 | 9.4 | .402 | 25.1 | .756 | 27.8 | .731 | 10 |
| frontend | W2V-LCNN [87] | 0.6 | — | 8.1 | — | 24.5 | — | — | — | N/A |
| (Section. | W2V + WLM | 1.8 | .916 | 22.5\| | .203 | 30.3 | .704 | 27.0 | .739 | 9 |
| [symbol] ) | W2V + HUB | 0.9 | .956 | 14.2 | .310 | 27.9 | .737 | 27.6 | .732 | 9 |
| | WLM + HUB | 0.8 | .963 | 16.7 | .269 | 29.2 | .724 | 28.5 | .720 | 9 |
| | SSL-Fusion [92] | 0.3 | .981 | 8.9 | .419 | 24.2 | .765 | 26.5 | .739 | 10 |
| | SLIM variants (ours) | | | | | | | | | |
| | Enc_{sty} | 6.7 | .740 | 8.6 | .438 | 29.2 | .724 | 25.4 | .756 | 9 |
| | Enc_{ling} | 5.9 | .764 | 9.3 | .407 | 30.4 | .708 | 25.0 | .760 | 9 |
| | Enc_{style+ling} | 3.5 | .834 | 9.0 | .429 | 25.1 | .757 | 23.9 | .772 | 10 |
| | Dependency | 2.8 | .897 | 20.5 | .234 | 25.8 | .750 | 19.8 | .811 | 9 |
| | Full | 0.6 | .969 | 8.3 | .451 | 12.9 | .895 | 13.5 | .865 | 11 |
| Finetuned | W2V-ASP (44) | 0.3 | .984 | 4.5 | .646 | 18.6 | .836 | 19.2 | .817 | 317 |
| frontend | W2V-AASIST [74] | 0.2 | .991 | 3.6 | .707 | 17.5 | .847 | 14.5 | .856 | 317 |
| (Section. | SLIM (ours) | 0.2 | .989 | 4.4 | .651 | 12.5 | .898 | 10.7 | .892 | 253 |
| [symbol] ) | | | | | | | | | | |

#Param refers to the number of trainable parameters (in millions). For SLIM, parameters trained at both stages were summed. A few models do not make their code open-source, therefore metrics reported in corresponding publications are included and parameter calculation is skipped (N/A). Lowest EERs are bolded per category.

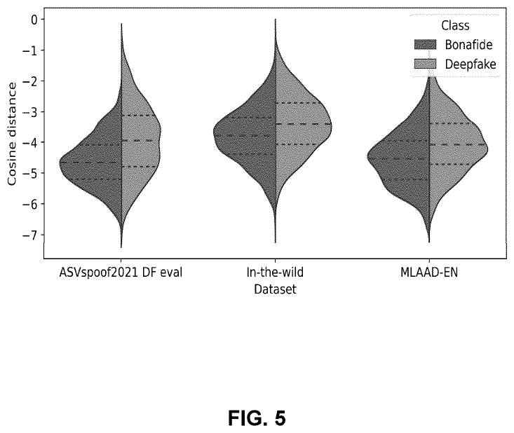

Style-linguistics mismatch of deepfakes: FIG. 5 shows the cosine distance calculated between the style and linguistics dependency features, where larger distance values suggests higher mismatch. Since the distance values follow a Gaussian distribution with unequal variances, a Welch's t-test was conducted to examine the statistical significance of the difference between bonafide and deepfake samples. For all three datasets, the average cosine distance is found significantly lower (p<1e-5) for bonafide speech than for deepfake samples. This corroborates with the hypothesis that a higher style-linguistics mismatch exists for deepfakes. On the other hand, the distance distributions of bonafide and deepfake samples still share a large overlap, indicating that dependency features alone are not sufficient for perfectly discriminating between the two classes. This also explains why using dependency features alone underperforms several benchmarks, especially on the ASVspoof2021.

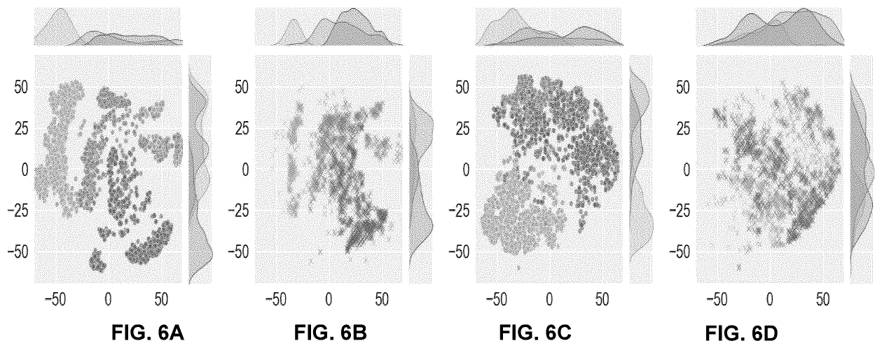

Analysis of style-linguistics dependency features. While Table 2 demonstrates that style linguistics dependency features can provide better generalizability than disentangled subspace embeddings, the reason behind the improvement is not well understood. Therefore, ASVspoof2021, In-the-wild, and MLAAD-EN, and project the dependency features as well as the concatenated subspace embeddings were first aggregated to a 2-dimensional space for visualization (FIG. 6). For an ideal representation, one would expect minimal shift between different dataset distributions, meanwhile maximal separation between bonafide and deepfake samples. These embeddings are inputs to the stage-2 training, i.e., not affected by backpropagation. Still, the dependency features show larger discrimination between bonafide and deepfakes (FIGS. 6C and 6D) than the concatenated subspace embeddings (FIGS. 6A and 6B), and less shift between datasets (compare FIGS. 6A and 6C, and FIGS. 6B and 6D).

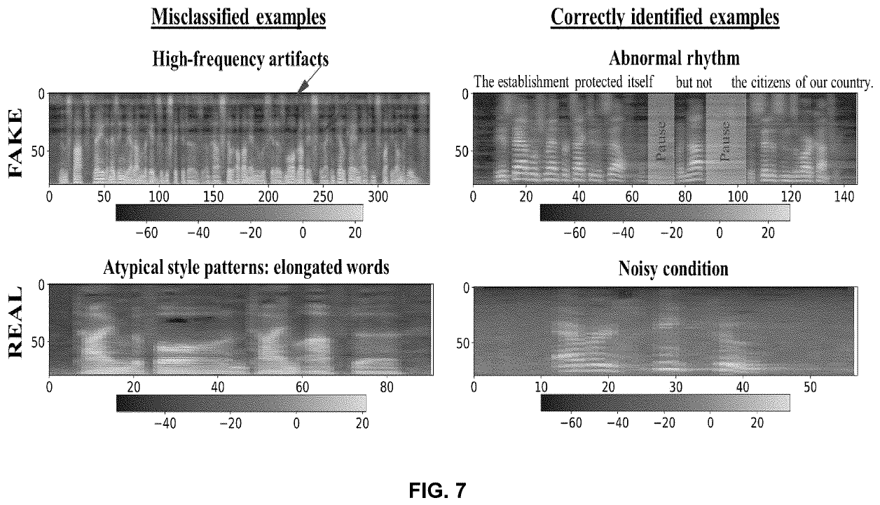

Next, a qualitative evaluation of model decisions was performed. First, samples that are correctly classified by the dependency features but missed by the SSL embeddings were pinpointed, and vice versa. FIG. 7 shows the mel-spectrograms of four samples selected from In-the-wild. These four were found with typical characteristics that can represent a larger group of recordings: the left column shows the ones that are missed by the dependency features but correctly identified by the subspace embeddings, whereas the right column shows the other way around. As seen in the top left plot, subspace embeddings alone are better at capturing deepfake imperfections, such as the high-frequency artifacts, which corroborates with the literature. Dependency features, on the other hand, are favored when the speech style does not match well with the verbal content. For example, the top right plot shows a generated sentence where abnormally long pauses can be heard before and after the phrase ‘but not’. Regarding real speech samples, misclassifications are usually made by dependency features where atypical style patterns exist, such as the elongated word pronunciations from an utterance by Alec Guinness (bottom left plot). Notwithstanding, the dependency features tend to be less sensitive to background noise, while SSL embeddings fail (bottom right plot). When the style-linguistics dependency features are fused with the subspace embeddings, all four samples can be correctly classified, demonstrating the complementarity between the two.

### Ablation Study

Effects of classification backend. For simplicity and minimizing computational complexity, SLIM adopts backend modules that have been widely used for processing universal representations, such as ASP and MLP. Previous works have shown that different backend architectures may lead to a significant difference in the detection performance. With the input fixed (dependency features and subspace embeddings), it is found that removing the ASP and MLP layers slightly increases the equal error rate, while using a LCNN or LGFF leads to a decrease on ASVspoof2019 and ASVspoof2021, but not necessarily on the other two out-of-domain datasets.

### DISCUSSION

Since the hypothesis assumes that deepfake samples are likely to exhibit style-linguistics mismatch, it is possible that some real speech samples with atypical style-linguistics dependency (e.g., similar to the example provided in FIG. 7) may be misclassified as deepfakes. One possible countermeasure is to increase the diversity of real speech samples used for the stage-1 self-supervised training.

This work presents SLIM, a new training framework that improves the generalizability and explainability of ADD systems by modelling the style-linguistics mismatch. Without costly fine-tuning large SSL encoders or the need for increasing labeled deepfake samples, SLIM largely outperforms benchmarks on out-of-domain data. Further analysis on the learned style-linguistics dependency features show their advantages in model explainability and complementarity to the subspace representations. Finally, the disclosure shows that SLIM can also benefit from frontend fine-tuning and more carefully designed backends, demonstrating its potential to be further improved in the future.

### APPENDIX

### Details of Generative Models Tested in the CCA Analysis

Details on the systems tested in Table. 1 are as follows. A01 is a TTS model that uses Flite that converts text into a sequence of linguistic features. A Hidden Markov Model (HMM) is then used to estimate the duration of phones. The acoustic features are predicted by an NN-based acoustic model, including MFCCs, F0, and voicing flags, which are input to the WaveNet vocoder for waveform synthesis. A02 and A03 follows a similar linguistic-acoustic-vocoder pipeline as A01, where A02 uses the WORLD vocoder and A03 relies on recipes from the Merlin toolbox. A04 is a waveform concatenation TTS model based on the MaryTTS platform, a major difference between A04 and the previous three models is that A04 preserves the short-term acoustic features of the natural speech, which may make it more difficult to separate from real speech. A05 and 06 are VC models. A05 encodes the spectral features into speaker-independent embeddings using a VAE and decode them with a desired target speaker representation. A06 relies on the source-filter modelling of speech where the conversion can be achieved by replacing the filters of the input signals by that of the target speaker. The non-speech segments are kept intact during conversion.

### Layer-Wise Analysis of Pretrained SSL Models

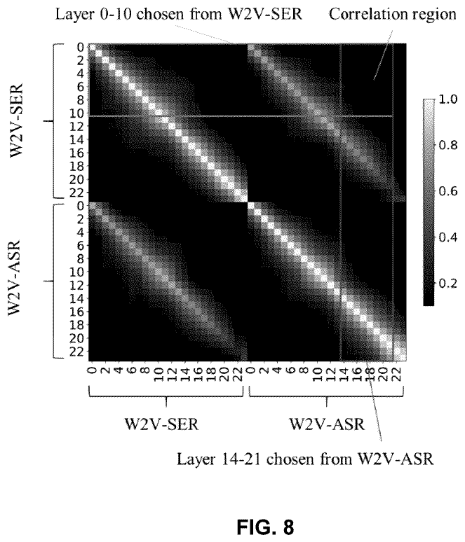

As mentioned above, the Wav2vec-XLSR model finetuned for emotion recognition (Wav2vec-SER) and speech recognition (Wav2vec-ASR) tasks were used to extract the style and linguistics representations, respectively. To obtain a maximal disentanglement between the two subspace representations, the Spearman's rank correlation coefficient values were calculated between different layers from the two models to examine the layer-wise similarity. These correlation values and the final layer selection are demonstrated in FIG. 8, which shows Spearman correlation coefficients calculated across all layers from two pretrained Wav2vec-XLSR backbones. Blue highlights layers 0-10 from Wav2vec-SER to represent style information. Red highlights layers 14-21 from Wav2vec-ASR to represent linguistics information. The correlation values between the selected layers can be read from the overlapping region. Based on existing works, which showed how linguistics and paralinguistics information propagate through layers, layer 0-10 from Wav2vec-SER backbone was chosen to represent style information, and layer 14-21 from Wav2vec-ASR backbone was chosen to represent linguistics information. The correlation values between these two groups are shown close to 0, indicating a better disentanglement.

### Dataset Details

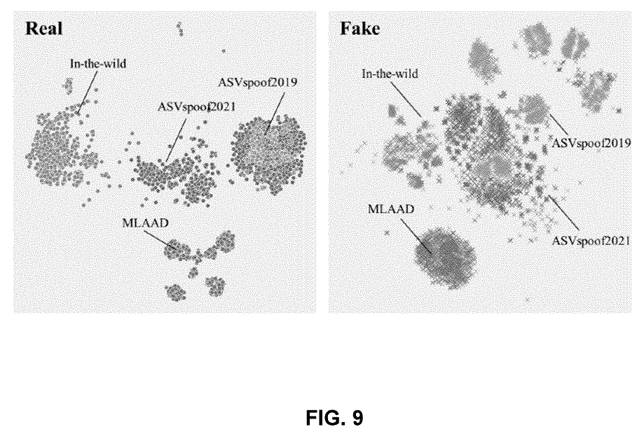

Table 3 describes the details of datasets used for Stage 1 and Stage 2 training and evaluation. FIG. 9 shows the projected WavLM embeddings for real and fake samples from the four employed datasets using t-SNE. WavLM was selected since it is the top-performing model in the single-encoder category (Table 2; Table 2.1). For both classes, an overlap can be seen between ASVspoof2019 and ASVspoof2021 samples, while samples from In-the-wild and MLAAD-EN can be separated nearly perfectly. This corroborates with the results reported in Table 2 where all employed ADD systems trained on ASVspoof2019 perform better on ASVspoof2021 than In-the-wild and MLAAD-EN.

TABLE 3
Summary of datasets used for Stage 1 and Stage 2 training and evaluation.

| | | | | | | | |
|---|---|---|---|---|---|---|---|
| Name | Split | #Sample | #Real | #Pake | #Attacks | Speech type | Environment |

Stage 1 datasets

| | | | | | | | |
|---|---|---|---|---|---|---|---|
| Common Voice | Train | 3k | 3k | — | — | Scripted | Crowdsourced |
| RAVDESS | Train | 3k | 3k | — | — | Scripted | Studio |
| 19 LA train | Valid | 500 | 500 | — | — | Scripted | Studio |

Stage 2 datasets

| | | | | | | | |
|---|---|---|---|---|---|---|---|
| 19 LA train | Train | 25380 | 2580 | 22800 | 6 | Scripted | Studio |
| 19 LA dev | Valid | 24884 | 2548 | 22336 | 6 | Scripted | Studio |
| 19 LA eval | Test | 71237 | 7355 | 63882 | 17 | Scripted | Studio |
| 21 DF eval | Test | 611829 | 22617 | 589212 | 100+ | Scripted | Studio |
| In-the-wild | Test | 31779 | 11816 | 19963 | N/A | Spontaneous | In-the-wild |
| MLAAD-EN | Test | 37998 | 18999 | 18999 | 25 | Scripted | Studio |

### Details of the Compression Model

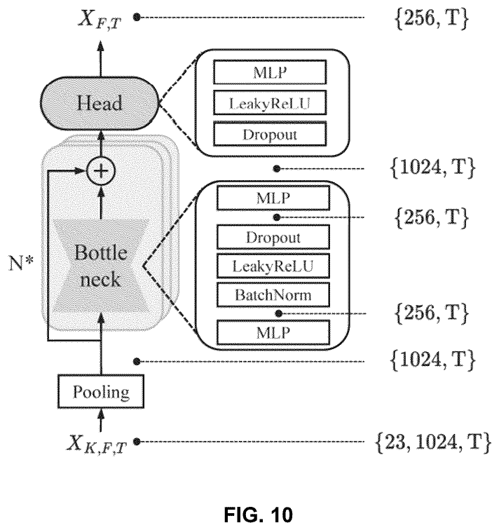

FIG. 10 shows the architecture of the compression module. The input X firstly passes through a pooling layer to obtain an average of different SSL layer outputs. Since the goal of compression modules is to project the original style/linguistics embeddings to a subspace where the compressed embeddings can be maximally correlated, bottleneck layers are utilized to remove the redundant information that is not shared across the two subspaces. Similar to the design of an autoencoder, the bottleneck layer firstly compresses the feature dimension from 1024-dim to 256-dim, then recovers it back to 1024-dim. In practice, it was found that using only one bottleneck layer is enough to obtain meaningful compressed representations. A projection head is applied at the end to reduce the final output dimension to 256.

### PyTorch Implementation of the Stage-1 Training Objective

Algorithm 1 provides an example PyTorch-style implementation that can be used for the stage-1 training objective, which comprises the cross-subspace distance loss and an intra-subspace redundancy loss. The subspace embeddings are first normalized across the whole batch before passing into the loss calculations. Two types of distance for the cross-subspace loss were assessed: the Euclidean and Cosine distance. While no significant difference is found when comparing the performance achieved by the two, the former provides slightly better results, hence is adopted as the final distance measure.

```

[symbol]

  Input: X_{style}, X_{linguistic} Output: L_{stage1}
  // Normalize embeddings from both subspaces
1 batch_size = x_{style.}shape[0]
2 X_{style}_norm = torch.nn.BatchNorm1d(x_{style}, affine=False) / batch_size
3 X_{linguistic}_norm = torch.nn.BatchNorm1d(x_{linguistic}, affine=False) /
  batch_size // Computation of cross-subspace distance loss
4 D = torch.linalg.norm(x_{style}_norm - x_{linguistic}_norm, ord='fro')
5 D = torch.pow(D, 2)
  // Computation of intra-subspace correlation loss
6 v_{linguistic} = torch.mm(x_{linguistic}_norm. T, x_{linguistic}_norm)
7 C_{linguistic} = torch.linalg.norm(v_{linguistic}-torch.eye(v_{linguistic.}shape[-1]))
8 C_{linguistic} = torch.pow(C_{linguistic}, 2)
9 v_{style} = torch.mm(xs_{tyle}_norm. T, v_{style}_norm)
10 C_{style} = torch.linalg.norm(v_{style}-torch.eye(v_{style}.shape[-1]))
11 C_{style} = torch.pow(C_{style}, 2)
  // Final loss term
12 L_{stage1} = D + λ (C_{style}+C_{linguistic}) [symbol]
indicates data missing or illegible when filed
```

### Performance Comparison of Different Backend Classifiers

Table 4 shows the performance obtained when the ASP+MLP layers are swapped with other layer choices.

| | EER | | | |
|---|---|---|---|---|
| SLIM | | | In-the- | MLAAD- |
| backend | ASVspoof2019 | ASVspoof2021 | wild | EN |
| Original | 0.6 | 8.3 | 12.9 | 13.5 |
| (ASP + MLP) | | | | |
| None | 0.9 | 9.1 | 13.1 | 13.7 |
| LLGF | 0.4 | 7.5 | 13.5 | 13.0 |
| LCNN | 0.3 | 7.9 | 12.8 | 13.9 |

### Hyperparameters

Tables 4 and 5 describe optional hyperparameters and architecture details of SLIM used for stage-1 and stage-2 training. The hyperparameter names of the data augmentation can be found in SpeechBrain v1.0.0.

TABLE 4
Hyperparameters and architecture details of SLIM.

| | |
|---|---|
| [symbol] Parameter | SLIM |

Stage-1 Optimization

| | |
|---|---|
| Batch size | 16 |
| Epochs | 50 |
| GPUs | 4 |
| Audio length | 5 s |
| Optimizer | AdamW. |
| LRscheduler | Linear |
| Starting LR | .005 |
| End LR | .0001 |
| Early-stop patience | 3 epochs |
| λ | .007 |
| Training time | 1 h |

SSL frontend

| | |
|---|---|
| Style encoder | Wav2vec-XLSR-SER |
| Style layers | 0-10 |
| Linguistic encoder | Wav2vec-XLSR-ASR-EN |
| Linguistic layers | 14-21 |

Compression module

| | |
|---|---|
| Bottleneck layers | 1 |
| BN dropout | 0.1 |
| FC dropout | 0.1 |
| Compression output dim | 255 |

Stage-2 Optimization

| | |
|---|---|
| Batch size 2 Epochs | 10 |
| GPUs | 4 |
| Audio length 5 s Optimizer | AdamW. |
| LRscheduler | Linear |
| Starting LR .0001 End LR | .00001 |
| Early-stop patience | 3 epochs |
| Training time | 10 h |

Classifier

| | |
|---|---|
| FC dropout | 0.25 |

Stage-2 data augmentation

| | |
|---|---|
| Num augmentations | 1 |
| Concat with original | True |
| Augment prob | 1 |
| Augment choices | Noise, Reverb, SpecAug\| |
| SNR_high | 15 dB |
| SNR_low | 0 dB |
| Reverb | RIR noise |
| Drop_freq_low | 0 |
| Drop_Freq_high | 1 |
| Drop_freq_count_low | 1 |
| Drop_freq_count_high | .05 |
| 3 Drop_freq _width | |
| Drop_chunk_count_low | 1 |
| Drop_chunk_count_high | 5 |
| Drop_chunk_length_low | 1000 |
| Drop_chunk_length_high | 2000 |

TABLE 5
Hyperparameters and architecture details of SLIM.

| | |
|---|---|
| Parameter | SLIM |

Stage 1 Optimization

| | |
|---|---|
| Batch size | 16 |
| Epochs | 50 |
| GPUs | 4 |
| Audio length | 5 s |
| Optimizer | AdamW |
| LRscheduler | Linear |
| Starting LR | .005 |
| End LR | .0001 |
| Early-stop patience | 3 epochs |
| λ | .007 |
| Training time | 3 h |

SSL frontend

| | |
|---|---|
| Style encoder | Wav2vec-XLSR-SER |
| Style layers | 0-10 |
| Linguistic encoder | Wav2vec-XLSR-ASR |
| Linguistic layers | 14-21 |

Compression module

| | |
|---|---|
| Bottleneck layers | 1 |
| BN dropout | 0.1 |
| FC dropout | 0.1 |
| Compression output dim | 256 |

Stage 2 Optimization

| | |
|---|---|
| Batch size | 2 |
| Epochs | 10 |
| GPUs | 4 |
| Audio length | 5 s |
| Optimizer | AdamW |
| LRscheduler | Linear |
| Starting LR | .0001 |
| End LR | .00001 |
| Early-stop patience | 3 epochs |
| Training time | 10 h |

Classifier

| | |
|---|---|
| FC dropout | 0.25 |

Stage 2 data augmentation

| | |
|---|---|
| Num augmentations | 1 |
| Concat with original | True |
| Augment prob | 1 |
| Augment choices | Noise, Reverb, SpecAug |
| SNR_high | 15 dB |
| SNR_low | 0 dB |
| Reverb | RIR noise |
| Drop_freq_low | 0 |
| Drop_Freq_high | 1 |
| Drop_freq_count_low | 1 |
| Drop_freq_count_high | 3 |
| Drop_freq_width | .05 |
| Drop_chunk_count_low | 1 |
| Drop_chunk_count_high | 5 |
| Drop_chunk_length_low | 1000 |
| Drop_chunk_length_high | 2000 |

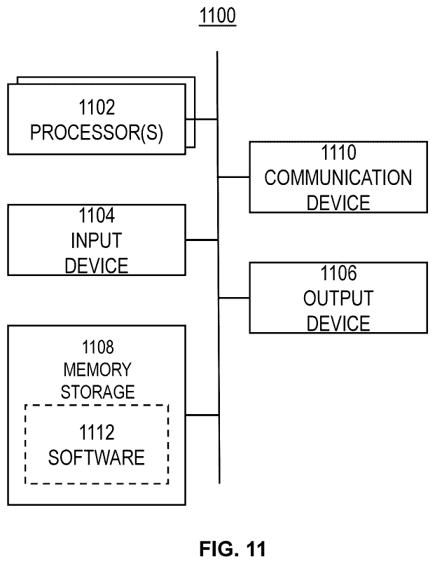

FIG. 11 shows a computer system 1100 that can be used to execute the methods disclosed herein. Computer system 1100 can be any suitable type of microprocessor-based device, such as a personal computer, workstation, server, or handheld computing device (portable electronic device) such as a phone or tablet, or dedicated device. As shown in FIG. 11, computer system 1100 may include one or more processors 1102, an input device 1104, an output device 1106, storage 1108, and a communication device 1110.

Input device 1104 and output device 1106 can be connectable or integrated with system 102. Input device 1104 may be any suitable device that provides input, such as a touch screen, keyboard or keypad, mouse, or voice-recognition device. Likewise, output device 1106 can be any suitable device that provides output, such as a display, touch screen, haptics device, or speaker.

Storage 1108 can be any suitable device that provides storage, such as an electrical, magnetic, or optical memory, including a RAM, cache, hard drive, removable storage disk, or other non-transitory computer readable medium. Communication device 1110 can include any suitable device capable of transmitting and receiving signals over a network, such as a network interface chip or device. The components of computer system 1100 can be connected in any suitable manner, such as via a physical bus or via a wireless network.

Processor(s) 1102 may be or comprise any suitable classical processor or combination of classical processors, including any of, or any combination of, a central processing unit (CPU), a field programmable gate array (FPGA), and an application-specific integrated circuit (ASIC). Software 1112, which can be stored in storage 1108 and executed by processor(s) 1102, can include, for example, the programming that embodies the functionality of the present disclosure. Software 1112 may be stored and/or transported within any non-transitory computer-readable storage medium for use by or in connection with an instruction execution system, apparatus, or device that can fetch instructions associated with the software from the instruction execution system, apparatus, or device and execute the instructions. In the context of this disclosure, a computer-readable storage medium can be any medium, such as storage 1108, that can contain or store programming for use by or in connection with an instruction execution system, apparatus, or device.

Software 1112 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Computer system 1100 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer system 1100 can implement any operating system suitable for operating on the network. Software 1112 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

As used herein, the singular forms “a”, “an”, and “the” include the plural reference unless the context clearly dictates otherwise. Reference to “about” a value or parameter or “approximately” a value or parameter herein includes (and describes) variations that are directed to that value or parameter per se. For example, description referring to “about X” includes description of “X”. It is understood that aspects and variations of the invention described herein include “consisting of” and/or “consisting essentially of” aspects and variations.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A method for classifying audio data, the method comprising:
inputting the audio data into a trained machine-learning model, wherein the trained machine-learning model is configured to:
generate, using a style encoder of the machine-learning model, one or more style embeddings representing nonverbal characteristics of the audio data;
generate, using a linguistic encoder of the machine-learning model, one or more linguistic embeddings representing textual content of the audio data;
generate one or more dependency embeddings representing dependencies between the one or more style embeddings and the one or more linguistic embeddings;
inputting the one or more dependency embeddings into a classification head of the machine-learning model; and
obtaining, from the trained machine-learning model, a classification result of whether the audio data is real or fake.

2. The method of claim 1, wherein the audio data comprises real human speech, synthetic human speech, or both real human speech and synthetic human speech.

3. The method of claim 1, wherein the one or more machine learning models have been trained using bona fide audio data to learn dependencies between nonverbal characteristics and textual content in real human speech.

4. The method of claim 1, wherein determining a first subset of the one or more dependency embeddings comprises:
inputting the one or more style embeddings into a style compressor;
compressing the one or more style embeddings to create one or more style dependency embeddings.

5. The method of claim 4, wherein determining a second subset of the one or more dependency embeddings comprises:
inputting the one or more linguistic embeddings into a linguistic compressor; and
compressing the one or more linguistic embeddings to create one or more linguistic dependency embeddings.

6. The method of claim 5, wherein the style compressor and the linguistics compressor have been trained to minimize a difference between the one or more style dependency embeddings and the one or more linguistic dependency embeddings by:
inputting bona fide audio data into the style encoder of the machine-learning model and the linguistic encoder of the machine-learning model;
generating one or more style embeddings representing nonverbal characteristics of the audio data using the style encoder;
generating one or more linguistic embeddings representing textual content of the audio data using the linguistic encoder;
inputting the one or more style embeddings into the style compressor;
compressing the one or more style embeddings to create one or more style dependency embeddings;
inputting the one or more linguistic embeddings into the linguistic compressor;
compressing the one or more linguistic embeddings to create one or more linguistic dependency embeddings; and
updating one or both of the style compressor and the linguistic compressor to minimize a difference between style dependency embeddings and linguistic dependency embeddings generated using the style compressor and the linguistic compressor.

7. The method of claim 6, wherein minimizing the difference between the one or more style dependency embeddings and the one or more linguistic dependency embeddings comprises minimizing a self-contrastive loss.

8. The method of claim 6, wherein the style compressor and the linguistics compressor have been trained via self-supervised learning using bona fide audio data comprising real human speech.

9. The method of claim 1, comprising: generating one or more supplementary style embeddings based on the one or more style embeddings, wherein the one or more supplementary style embeddings include information-rich portions of the input audio data.

10. The method of claim 9, comprising: generating one or more supplementary linguistic embeddings based on the one or more linguistic embeddings, wherein the one or more supplementary linguistic embeddings include information-rich portions of the input audio data.

11. The method of claim 10, comprising:
concatenating the one or more supplementary style embeddings, one or more supplementary linguistic embeddings, one or more style dependency embeddings, and one or more linguistic dependency embeddings to one another; and
inputting the concatenated embeddings into the classifier module.

12. The method of claim 10, wherein the one or more supplementary style embeddings and one or more supplementary linguistic embeddings are generated using an attentive statistics pooling module and a multi-layer perceptron module.

13. The method of claim 1, wherein the one or more style embeddings represent one or more attributes selected from the group comprising: speaker identity, gender, emotion, accent, tone, speech rate, health state, age, vocal pitch, vocal intensity, and cognitive state.

14. The method of claim 1, wherein the classification head has been trained to classify audio as real or fake via supervised learning using labeled audio data.

15. The method of claim 1, wherein the style compressor and the linguistics compressor are trained in a first training phase using only bona fide audio data, and wherein the classification head is trained during a second training phase using labeled bona fide audio data and labeled fake audio data.

16. The method of claim 1, comprising: permitting access to a computing resource or protected endpoint based on the classification result, wherein the classification result indicates that the audio is real.

17. The method of claim 1, comprising: restricting access to a computing resource or protected endpoint based on the classification result, wherein the classification result indicates that the audio is fake.

18. The method of claim 1, comprising: displaying an alert via a user interface based on the classification result, wherein the classification result indicates that the audio is fake.

19. A system for classifying audio data comprises: one or more processors, a memory, and one or more programs, wherein the one or more programs are stored in the memory and configured to be executed by the one or more processors, the one or more programs including instructions for:
inputting the audio data into a trained machine-learning model, wherein the trained machine-learning model is configured to:
generate, using a style encoder of the machine-learning model, one or more style embeddings representing nonverbal characteristics of the audio data;
generate, using a linguistic encoder of the machine-learning model, one or more linguistic embeddings representing textual content of the audio data;
generate one or more dependency embeddings representing dependencies between the one or more style embeddings and the one or more linguistic embeddings;
inputting the one or more dependency embeddings into a classification head of the machine-learning model; and
obtaining, from the trained machine-learning model, a classification result of whether the audio data is real or fake.

20. A non-transitory computer-readable storage medium storing one or more programs for detecting deepfake images in a video, the one or more programs comprising instructions, which when executed by one or more processors of an electronic device, cause the electronic device to:
input the audio data into a trained machine-learning model, wherein the trained machine-learning model is configured to:
generate, using a style encoder of the machine-learning model, one or more style embeddings representing nonverbal characteristics of the audio data;
generate, using a linguistic encoder of the machine-learning model, one or more linguistic embeddings representing textual content of the audio data;
generate one or more dependency embeddings representing dependencies between the one or more style embeddings and the one or more linguistic embeddings;
input the one or more dependency embeddings into a classification head of the machine-learning model; and
obtain, from the trained machine-learning model, a classification result of whether the audio data is real or fake.
